(19) United States
(12) Patent Application Publication
(10) Pub. No.: US 2015/0309680 A1
(43) Pub. Date: Oct. 29, 2015

(54) ELECTRONIC-BOOK DISPLAY PROCESSING PROGRAM AND ELECTRONIC-BOOK SYSTEM

(71) Applicant: SQUARE ENIX CO., LTD., Tokyo (JP)

(72) Inventors: Eiri HIGUCHI, Tokyo (JP); Makiko KITAMURA, Tokyo (JP)

(73) Assignee: SQUARE ENIX CO., LTD., Tokyo (JP)

(21) Appl. No.: 14/680,107

(22) Filed: Apr. 7, 2015

(30) Foreign Application Priority Data
Apr. 28, 2014 (JP) 2014-92229

(51) Int. Cl. G06F 3/0483; G06F 17/21

(52) U.S. Cl. CPC G06F 3/0483; G06F 17/212

(57) ABSTRACT

To provide an electronic-book display processing program for displaying a passage of an electronic book which has the same content as a paper book on a display portion of a terminal device based on electronic book data including reflowable document data, which allows a computer to execute a passage specifying function which extracts part of the electronic book data including data corresponding to a passage written in a page of the paper book corresponding to a page number based on the page number of the paper book designated by the user through an operating portion of the terminal device, a page-number specifying function which specifies a page number of a page of the paper book in which at least part of display information is written from the electronic book data based on the display information of the electronic book displayed on the display portion.

### BACKGROUND OF THE INVENTION

1. Field of the Invention

At least one of embodiments of the present invention relates to an electronic-book display processing program and so on for allowing a computer to execute a function of displaying a passage of a reflowable electronic book having the same content as a paper book on a display portion of a terminal device.

2. Description of Related Art

In recent years, the electronic book used in a tablet, a dedicated terminal device (terminal device) and so on is becoming popular, and various functions relating to the electronic book are provided for making a user to read the book easily (for example, refer to JP-A-2014-10730). There are various ways of using the electronic book, and there exists a user who possesses the electronic book and the paper book having the same content as the electronic book and uses them according to places. There are a reflowable data format and a fix-type data format in the electronic books. In general, the reflowable is applied to the electronic books such as novels and the fix-type is applied to the electronic books such as comics.

The reflowable electronic book is basically formed of character data not having the concept of pages. In the reflowable electronic book, a document is displayed in a state corresponding to a setting of the display size of characters in the terminal device and so on. That is, the state of display is changed in accordance with the setting of the display size and so on in the reflowable electronic book. The content displayed on one screen of the terminal device corresponds to one page in consequence in the reflowable electronic book. Therefore, fixed page numbers as in the paper book are not set in the reflowable electronic book. On the other hand, in the fix-type electronic book, there is the concept of pages in the same manner as the paper book, in which the layout of characters and so on is fixed.

A configuration example of a reading system for browsing the electronic book is disclosed in JP-A-2012-252453.

The concept of pages does not exist in the reflowable electronic book as described above. Therefore, in the case where two media which are the reflowable electronic book and the paper book are used, when the reading is started from a position where the user has read (stopped reading) in one medium by using the other medium, it is necessary to search for a position corresponding to the position where the user has read in one medium from the other medium, which causes a problem that a process of performing the search is troublesome for the user.

### SUMMARY OF THE INVENTION

An objective of at least one of the embodiments of the present application is to overcome one or more of the deficiencies in the related art.

According to a first non-limiting aspect, the present invention relates to an electronic-book display processing program for allowing a computer to execute a function of displaying a passage of an electronic book which has the same content as a paper book on a display portion of a terminal device based on electronic book data including reflowable document data, which allows the computer to execute a passage specifying function which extracts part of the electronic book data including data corresponding to a passage written in a page of the paper book corresponding to a page number based on the page number of the paper book designated by the user through an operating portion of the terminal device from a storage unit storing the electronic book data so as to be associated with page numbers of the paper book, a page-number specifying function which specifies a page number of a page of the paper book in which at least part of display information is written from the electronic book data based on the display information of the electronic book displayed on the display portion, and a display control function which displays the passage on the display portion based on the electronic book data, in which a passage corresponding to part of the extracted electronic book data is displayed on the display portion and the specified page number is displayed on the display portion in the display control function.

According to a second non-limiting aspect, the present invention relates to an electronic-book display processing program for allowing a server device connected to a terminal device through a communication network, which has a display portion displaying a document of an electronic book which has the same content as a paper book based on electronic book data including document data of a reflowable format, to control the content of the electronic book to be displayed on the display portion, which allows the server device to execute a passage specifying function which extracts part of the electronic book data including data corresponding to a passage written in a page of the paper book corresponding to a page number based on the page number of the paper book designated by the user from a storage unit storing the electronic book data so as to be associated with page numbers of the paper book through an operating portion of the terminal device, a page-number specifying function which specifies a page number of a page of the paper book in which at least part of display information from the electronic book data based on the display information of the electronic book displayed on the display portion, and a display control function which displays the passage on the display portion based on the electronic book data, in which the passage corresponding to part of the extracted electronic book data is displayed on the display portion and the specified page number is displayed on the display portion in the display control function.

According to a third non-limiting aspect, the present invention relates to an electronic-book system including a terminal device having a display means for displaying a document of an electronic book which has the same content as a paper book based on electronic book data including document data of a reflowable format and a server device connected to the terminal device through a communication network, which includes a storage means for storing the electronic book data so as to be associated with page numbers of the paper book, a passage specifying means for extracting part of the electronic book data including data corresponding to a passage written in a page of the paper book corresponding to a page number based on the page number of the paper book designated by the user from the storage means through an operating means of the terminal device, a page-number specifying means for specifying a page number of a page of the paper book in which at least part of display information is written from the electronic book data based on the display information of the electronic book displayed on the display means, and a display control means for displaying the document on the display means based on the electronic book data, in which the display control means displays the passage corresponding to part of the extracted electronic book data on the display means and displays the specified page number on the display means.

One or more of the deficiencies are overcome by each of the embodiments of the present application.

### BRIEF DESCRIPTION OF THE DRAWINGS

FIG. 1 is a block diagram showing an example of a configuration of an electronic-book system according to at least one of embodiments of the present invention;

FIG. 2 is a block diagram showing a configuration of a server device according to at least one of embodiments of the present invention;

FIG. 3A is an explanatory view for explaining electronic book data according to at least one of embodiments of the present invention;

FIG. 3B is an explanatory view for explaining paper book page information according to at least one of embodiments of the present invention;

FIG. 4 is a flowchart showing an example of display processing according to at least one of embodiments of the present invention;

FIG. 5 is a flowchart showing an example of operations in the server device side in the display processing according to at least one of embodiments of the present invention;

FIG. 6 is a flowchart showing an example of operations in the terminal device side at the time of performing the display processing by the terminal device according to at least one of embodiments of the present invention;

FIG. 7A is a view showing an example of an image displayed on a display portion of a terminal device according to at least one of embodiments of the present invention;

FIG. 7B is a view showing an example of an image displayed on the display portion of the terminal device according to at least one of embodiments of the present invention;

FIG. 8 is a block diagram showing a configuration of a server device according to at least one of embodiments of the present invention;

FIG. 9 is a flowchart showing an example of display processing according to at least one of embodiments of the present invention;

FIG. 10 is a block diagram showing a configuration of a server device according to at least one of embodiments of the present invention;

FIG. 11 is a block diagram showing a configuration of a server device according to at least one of embodiments of the present invention;

FIG. 12 is a flowchart showing an example of display processing according to at least one of embodiments of the present invention;

FIG. 13A is a view showing an example of an image displayed on the display portion of the terminal device according to at least one of embodiments of the present invention;

FIG. 13B is a view showing an example of an image displayed on the display portion of the terminal device according to at least one of embodiments of the present invention;

FIG. 14 is a block diagram showing a configuration of a server device according to at least one of embodiments of the present invention;

FIG. 15A is an explanatory view for explaining electronic book data according to at least one of embodiments of the present invention;

FIG. 15B is an explanatory view for explaining paper book page information according to at least one of embodiments of the present invention;

FIG. 16 is a flowchart showing an example of display processing according to at least one of embodiments of the present invention;

FIG. 17 is a block diagram showing a configuration of a server device according to at least one of embodiments of the present invention;

FIG. 18 is an explanatory view for explaining user information according to at least one of embodiments of the present invention;

FIG. 19 is a flowchart showing an example of display processing according to at least one of embodiments of the present invention;

FIG. 20 is a block diagram showing a configuration of a server device according to at least one of embodiments of the present invention;

FIG. 21A is a view showing an example of an image displayed on the display portion of the terminal device according to at least one of embodiments of the present invention;

FIG. 21B is a view showing an example of an image displayed on the display portion of the terminal device according to at least one of embodiments of the present invention;

FIG. 22 is a flowchart showing an example of display processing according to at least one of embodiments of the present invention;

FIG. 23 is a block diagram showing a configuration of a server device according to at least one of embodiments of the present invention;

FIG. 24A is a view showing an example of the content of a page of a paper book according to at least one of embodiments of the present invention;

FIG. 24B is a view showing an example of an image displayed on the display portion of the terminal device according to at least one of embodiments of the present invention;

FIG. 24C is a view showing an example of an image displayed on the display portion of the terminal device according to at least one of embodiments of the present invention;

FIG. 25A is a view showing an example of an image displayed on the display portion of the terminal device according to at least one of embodiments of the present invention;

FIG. 25B is a view showing an example of an image displayed on the display portion of the terminal device according to at least one of embodiments of the present invention;

FIG. 26 is a flowchart showing an example of display processing according to at least one of embodiments of the present invention;

FIG. 27 is a flowchart showing an example of processing of setting a space between lines according to at least one of embodiments of the present invention;

FIG. 28 is a block diagram showing a configuration of a server device according to at least one of embodiments of the present invention;

FIG. 29 is an explanatory view for explaining paper book page information according to at least one of embodiments of the present invention;

FIG. 30 is a flowchart showing an example of the processing of setting the space between lines according to at least one of embodiments of the present invention;

FIG. 31 is a view showing an example of an image displayed on the display portion of the terminal device according to at least one of embodiments of the present invention; and

FIG. 32 is a flowchart showing an example of the processing of setting the space between lines according to at least one of embodiments of the present invention.

### DESCRIPTION OF EMBODIMENTS

Hereinafter, some examples of embodiments of the present invention will be explained with reference to the drawings. Various kinds of components (or elements) in the example of respective embodiments explained below can be suitably combined within a range in which any contradiction does not occur. The explanation of the content as an example of one embodiment maybe omitted in another embodiment. The content of operations and/or processes not concerned to characterizing portions of respective embodiments may be omitted. Furthermore, various processes forming various flows explained below are in no particular order within a range in which any contradiction does not occur in the content of processes.

### First Embodiment

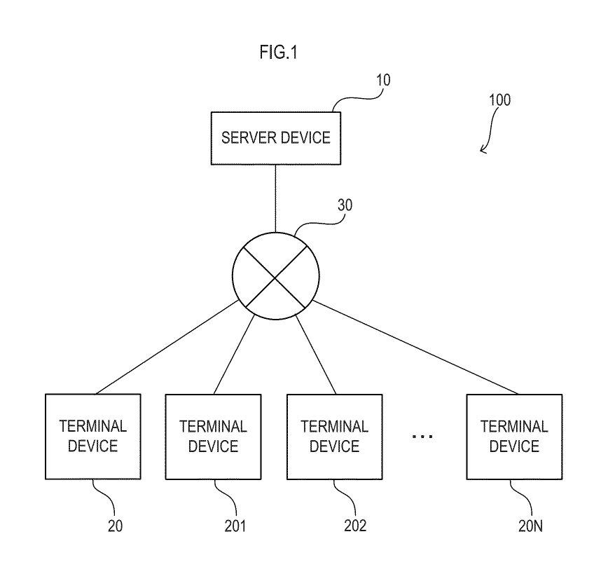

FIG. 1 is a block diagram showing an example of a configuration of an electronic-book system 100 according to an embodiment of the present invention. As shown in FIG. 1, the electronic-book system 100 includes a server device 10 of electronic books and terminal devices 20, 201 to 20N (N is an arbitrary integer) used by a user. The server device 10 and plural terminal devices 20, 201 to 20N are respectively connected to a communication network 30 such as Internet. The configuration of the electronic-book system 100 is not limited to this, and a configuration in which a single terminal device is used by plural players as well as a configuration in which plural server devices are included can be applied.

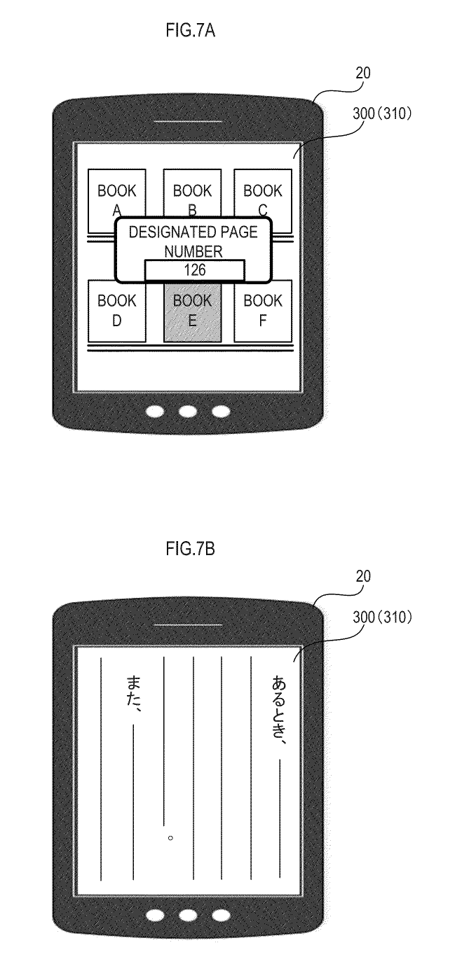

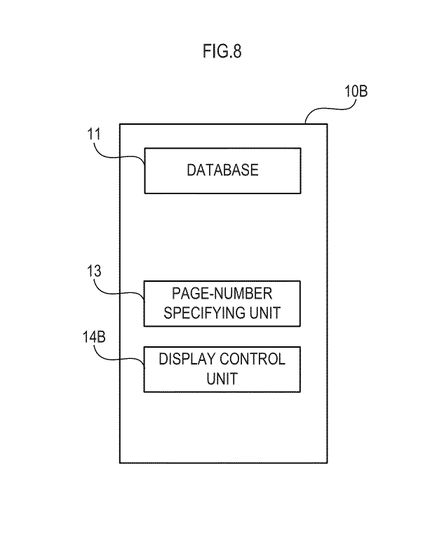

The electronic-book system 100 displays a passage of an electronic book on a display portion 300 (refer to FIG. 7A) of the terminal devices 20, 201 to 20N based on electronic book data including document data of a reflowable data format. The electronic-book system 100 also stores page number information of a paper book having the same content as the electronic book. When the user designates a page number of the paper book having the same content as the electronic book at the time of browsing the electronic book, the electronic-book system 100 displays part of the passage written in a page of the paper book corresponding to the designated page number on the display portion 300. The same content for the electronic book and the paper book means that the content (passages and so on) of respective books are the same.

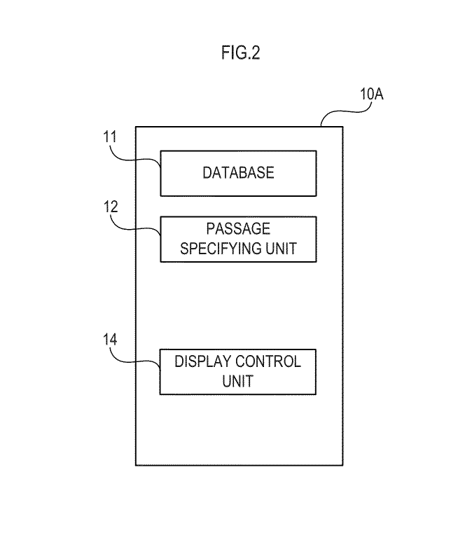

The server device 10 is administered by an administrator of the electronic-book system 100, having various functions for providing information concerning the electronic book to the terminal devices 20, 201 to 20N. For example, the server device 10 provides information of passages of the electronic books to be displayed on the display portion 300 of the terminal devices 20, 201 to 20N. In the embodiment, the server device 10 is formed of an information processing device such as a WWW server, including a database 11 (refer to FIG. 2) which stores various information such as electronic book data.

FIG. 2 is a block diagram showing a configuration of a server device 10A as an example of a configuration of the server device 10. The server device 10A has a control unit and so on formed of a storage unit such as a not-shown HDD, a CPU and the like. The control unit controls the display and so on of the electronic book by executing an electronic-book display processing program stored in the storage unit. The server device 10A includes at least the database (storage unit) 11, a passage specifying unit 12 and a display control unit 14 by executing the above program. The server device 10A has a common configuration including the above control unit, a communication unit and so on, which are for displaying the electronic book though the explanation is omitted here.

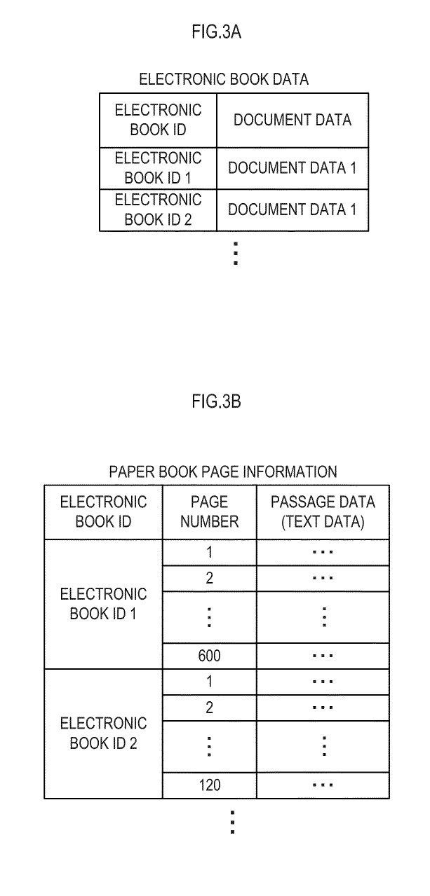

The database 11 stores plural electronic book data, the paper book page information and so on. The electronic book data is data for displaying the passage of the electronic book on the display portion 300, including document data associated with electronic book IDs shown in FIG. 3A and so on. FIG. 3A is an explanatory view for explaining electronic book data. The electronic book ID is unique identification information given to each electronic book. The document data includes passages (text data) of the electronic book (electronic book ID). The document data is written in EPUB, AZW standards as data formats for the reflowable electronic book, also including paragraph information (line feed information), headword information and so on.

Here, the passage means a unit including one or more sentences, and the document means a passage group including one or more passages, which corresponding to a book. That is, one document data includes the passages (text data) of the whole of one electronic book.

Plural paper book page information (page information) are stored in units of respective electronic book (electronic book IDs), which is referred to when specifying the passage of the electronic book corresponding to the page number of the paper book. The page information includes page numbers associated with the electronic book IDs and passage data as shown in FIG. 3B. The page numbers are page numbers of the paper book having the same content as the electronic book. The passage data is associated with the page numbers, which is passage data (text data) written in pages of the paper book corresponding to the page numbers. FIG. 3B is an explanatory view for explaining page information.

The passage specifying unit 12 extracts part of the electronic book data corresponding to the passage written in a page of the paper book corresponding to a page number designated by the user based on the page information. The display control unit 14 displays the passage and the like on the display portion 300 based on the electronic book data. For example, the display control unit 14 extracts data (data for display) of one screen to be displayed on the display portion 300 from the electronic book data and transmits the data to the terminal device 20. That is, the data for display corresponds to part of the electronic book data. The display control unit 14 also displays the passage and so on corresponding to part of the electronic book data extracted by the passage specifying unit 12 on the display portion 300.

The plural terminal devices 20, 201 to 20N are respectively administered by users using the electronic books, which include communication terminals having the display portion which can display the passage and so on of the electronic book such as a personal computer, a cellular phone terminal, a PDA (Personal Digital Assistants) and a portable game device.

The plural terminal devices 20, 201 to 20N are respectively connected to the communication network 30, including hardware (for example, an operating portion such as a touch panel device 310 (refer to FIG. 7A) for inputting the page number and so on, the display portion 300 displaying the passage of the electronic book and so on) and software for displaying the passage and the like of the electronic book by performing communication with the server device 10. The detailed explanation of a technique of displaying the passage of the electronic book is omitted as that is the common technique.

Next, operations of the electronic-book system 100 (system 100) according to the embodiment will be explained.

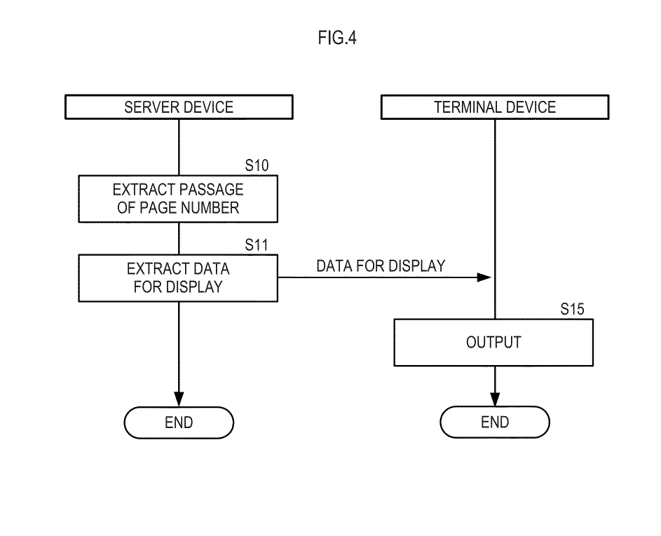

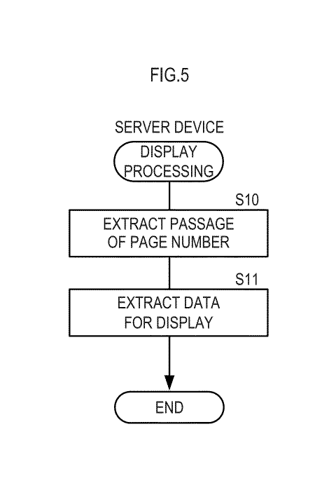

FIG. 4 is a flowchart showing an example of electronic book display processing executed by the system 100. In the electronic book display processing (display processing) in the example, when the user designates a page number of the paper book, processing for displaying the passage of the electronic book corresponding to the page number of the paper book on the display portion 300 is performed. Hereinafter, a case where the display processing performed by the server device 10A and the terminal device 20 (terminal 20) will be explained as an example.

The display processing in the present example is started, for example, when the server device 10A receives information of the page number designated by the user from the terminal 20 with the electronic book ID and so on of the electronic book corresponding to the paper book.

In the display processing, the server device 10A reads the page information of the electronic book (electronic book ID) corresponding to the paper book from the database 11 and extracts a passage (passage data) corresponding to a page number designated by the user (Step S10). Next, the server device 10A reads the electronic book data corresponding to the electronic book ID and extracts data (data for display) corresponding to the passage extracted in the processing of Step S10 from the electronic book data (Step S11).

On the other hand, the terminal 20 receives the data for display from the server device 10A and displays (outputs) the passage of the electronic book based on the data for display on the display portion 300 (Step S15).

FIG. 5 is a flowchart showing an example of operations in the server device 10A side in the above display processing. In the display processing, the server device 10A reads the page information of the electronic book (electronic book ID) corresponding to the paper book from the database 11 and extracts the passage (passage data) corresponding to the page number designated by the user (Step S10). Next, the server device 10A reads the electronic book data corresponding to the electronic book ID and extracts data (data for display) corresponding to the passage extracted in Step S10 from the electronic book data (Step S11). In the example, the server device 10A performs processing for displaying the passage of the page corresponding to the paper book in the page number designated by the user on the display portion 300 of the terminal 20.

As the server device 10A includes the database 11, the passage specifying unit 12 and the display control unit 14 as an aspect of the first embodiment as described above, it is possible to display the passage corresponding to the page of the page number of the paper book on the display portion 300 by the simple operation of the user. Therefore, for example, the user who is reading both the electronic book and the paper book having the same content can restart the reading in the electronic book from a place where the reading is stopped in the paper book easily.

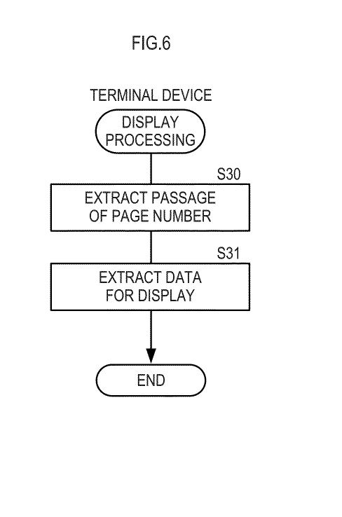

FIG. 6 is a flowchart showing an example of operations in the terminal 20 side at the time of performing the display processing shown in FIG. 4 by the terminal 20. In the display processing, the terminal 20 reads the page information of the electronic book (electronic book ID) corresponding to the paper book from the database 11 and extracts the passage (passage data) corresponding to the page number designated by the user (Step S30). Next, the terminal 20 reads the electronic book data corresponding to the electronic book ID and extracts data (data for display) corresponding to the passage extracted in Step S30 from the electronic book data (Step S31). That is, in the present example, the terminal 20 performs processing for displaying the passage of the page corresponding to the paper book in the page number designated by the user on the display portion 300 of the terminal 20. After that, the terminal 20 displays the passage of the electronic book on the display portion 300 based on the data for display as described above.

Although the user designates the page number by operating the operating portion of the terminal 20 in the above example of the first embodiment, any configuration may be applied as long as the page number is designated by operating the operating portion of the terminal 20. For example, the page number may be designated by the user by using the touch panel device 310 of the terminal 20 as shown in FIGS. 7A and 7B. FIGS. 7A and 7B are views showing examples of images displayed on the display portion 300 of the terminal 20. The display portion 300 is a liquid crystal display, and the touch panel display 310 is arranged on the surface thereof.

FIG. 7A shows a state where icon images of electronic books A to F as well as a window image of designating the page number are displayed on the display portion 300. The electronic books A to F are books which have been purchased by the user. The information of the purchased books is stored in the database 11 of the server device 10A as user information. The user designates the page number after selecting (touch operation) one of the displayed icon images of the electronic books A to F. FIG. 7A shows a state where the electronic book E is selected and 126 is designated as the page number. The page number can be inputted by performing a touch operation of a software keyboard (not shown).

Next, the designation of the page number is completed by performing a touch operation of a determination key (not shown), and the electronic book ID and the page number are transmitted from the terminal 20 to the server device 10A. After that, the passage corresponding to the designated page number of the paper book is displayed on the display portion 300 as shown in FIG. 7B. Straight lines shown in FIG. 7B indicate character strings. Although the entire passage in the page corresponding to the designated page number is displayed in the above example, it is sufficient that at least part of the passage is displayed. A writing direction of the passage displayed on the display portion 300 shown in FIG. 7B and respective embodiments as examples is a vertical direction from right to left (vertical writing from the right), however, the passage may be written in a horizontal direction.

The electronic book data in the example of the above first embodiment may further includes image data of an illustration and so on.

In the example of the above first embodiment, the server device 10A includes the database 11, however, it is also preferable that the database 11 exists inside the electronic-book system 100 as well as outside the system 100 as long as the database 11 is connected to the server device 10A so as to communicate with each other.

Furthermore, the case where the server device 10A has various functions has been explained as the example in the above embodiment 1, however, it is also preferable that a user terminal (for example, the terminal 20), not the server device, has part or all of various functions included in the server device 10A.

### Second Embodiment

FIG. 8 is a block diagram showing a configuration of a server device 10B as an example of the server device 10. In the example, the server device 10B includes at least the database (storage unit) 11, a page-number specifying unit 13 and a display control unit 14B. The server device 10B does not have the passage specifying function of the first embodiment.

The page-number specifying unit 13 specifies a page number of a page of the paper book in which display information of the electronic book displayed on the display portion 300 of the terminal 20 is written. The display control unit 14B displays the passage and the like on the display portion 300 based on the electronic book data. The display control unit 14B displays the specified page number of the paper book on the display portion 300.

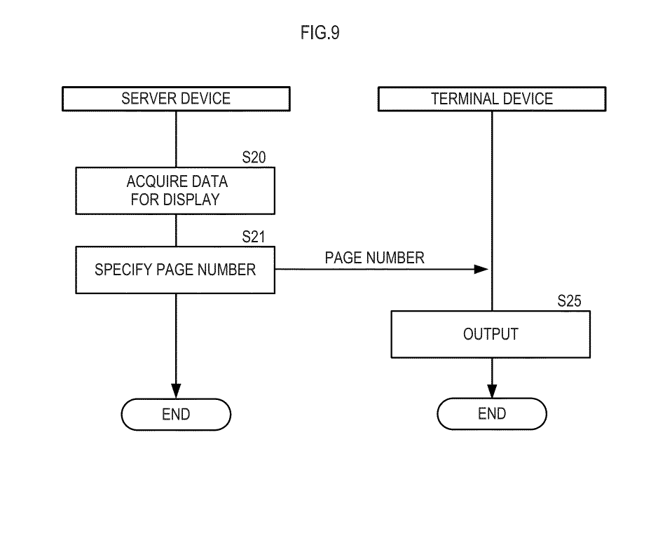

FIG. 9 is a flowchart showing an example of display processing executed by the system 100. In the display processing in the example, processing for specifying the page number of the page of the paper book in which display information of the electronic book displayed on the display portion 300 of the terminal 20 is written is performed. Hereinafter, operations of the server device 10B and the terminal 20 will be explained as an example. Note that flowcharts showing respective operations of the server device 10B and the terminal 20 are not shown from the viewpoint of avoiding repeated explanation.

The display processing of the example is started, for example, when the server device 10B receives a request for the page number of the paper book from the terminal 20.

In the display processing, the server device 10B acquires the display information (data for display) which is currently displayed on the display portion 300 from the electronic book data (Step S20). Next, the server device 10B reads the page information of the electronic book (electronic book ID) corresponding to the data for display from the database 11 and specifies the page number of the page of the paper book in which the display information of the electronic book is written (Step S21). For example, the server device 10B specifies the page number from the passage included in the data for display by referring to the page information.

On the other hand, the terminal 20 receives information of the page number from the server device 10B and displays the page number on the display portion 300 (Step S25).

As the server device 10B includes the database 11, the page-number specifying unit 13 and the display control unit 14B as an aspect of the second embodiment as described above, it is possible to figure out the page number of the paper book corresponding to the content of the electronic book displayed on the display portion 300 by the simple operation of the user. Therefore, for example, the user who is reading both the electronic book and the paper book having the same content can restart the reading in the paper book from a place where the reading is stopped in the electronic book easily.

In the processing of Step S20 in the above display processing, the data for display acquired by the server device 10B is, for example, data transmitted to the terminal 20 by the server device 10B for being displayed on the display portion 300. As the data for display, data held in the server device 10B even after the transmission to the terminal 20 may be used as well as data may be received from the terminal 20 at the time of requesting the page number by the terminal 20.

Also in the above example of the second embodiment, the user requests the display of the page number by operating the operating portion of the terminal 20, however, any configuration may be applied as long as the request is made through the operating portion of the terminal 20. It is also preferable, for example, to display the page number on the display portion 300 constantly even when not requiring the page number.

Furthermore, in the above example of the second embodiment, when the display information on the display portion 300 of the terminal 20 corresponds to plural pages in the paper book, information of corresponding plural page numbers can be transmitted from the server device 10B to the terminal 20. It is also preferable to transmit one of the plural page numbers as long as at least part of page numbers of pages of the paper book corresponding to the display information of the electronic book is specified.

Although the page number is specified from the passages included in the data for display by referring to the page information in the above example of the second embodiment, it is also preferable that the page number is specified from the entire passage displayed on the display portion 300 as well as preferable that the page number is specified from part of the passage displayed on the display portion 300. When the display information displayed on the display portion 300 includes an illustration (image), the page number can be specified from the illustration. In this case, illustration data (image data) and so on may be included in electronic book data and information for specifying the page number of the paper book in which the illustration data is written may be included in the page information.

Additionally, the case where the server device 10B has various functions has been explained in the above example of the second embodiment, however, it is also preferable that the user terminal (for example, the terminal 20), not the server device, has part or all of various functions included in the server device 10B.

### Third Embodiment

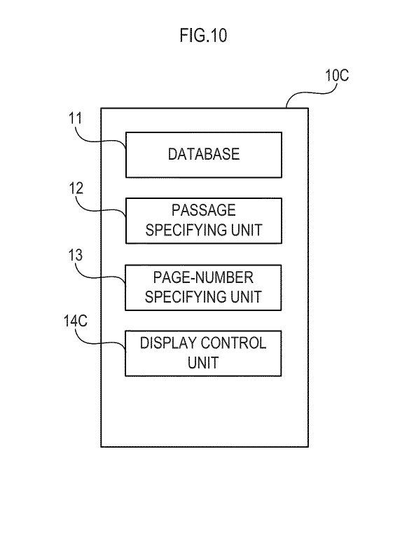

FIG. 10 is a block diagram showing a configuration of a server device 10C as an example of the server device 10. In the example, the server device 10C includes at least the database (storage unit) 11, the passage specifying unit 12, the page-number specifying unit 13 and a display control unit 14C.

The display control unit 14C displays the passage and the like on the display portion 300 based on the electronic book data. The display control unit 14C displays the passage and the like corresponding to part of the electronic book data extracted by the passage specifying unit 12 on the display portion 300. The display control unit 14C further displays a page number of the paper book specified by the page-number specifying unit 13 on the display portion 300. As the display processing executed by the system 100 is the same as those of the above first embodiment and the second embodiment, the explanation thereof is omitted.

As the server device 10C includes the database 11, the passage specifying unit 12, the page-number specifying unit 13 and the display control unit 14C as an aspect of the third embodiment as described above, it is possible to display the passage corresponding to the page number of the paper book on the display portion 300 by the simple operation of the user. It is also possible to figure out the page number of the paper book corresponding to the content of the electronic book displayed on the display portion 300 by the simple operation of the user. Accordingly, the user friendliness is extremely high for the user, for example, who is reading both the electronic book and the paper book having the same content.

Additionally, the case where the server device 10C has various functions has been explained in the above example of the third embodiment, however, it is also preferable that the user terminal (for example, the terminal 20), not the server device, has part or all of various functions included in the server device 10C.

### Fourth Embodiment

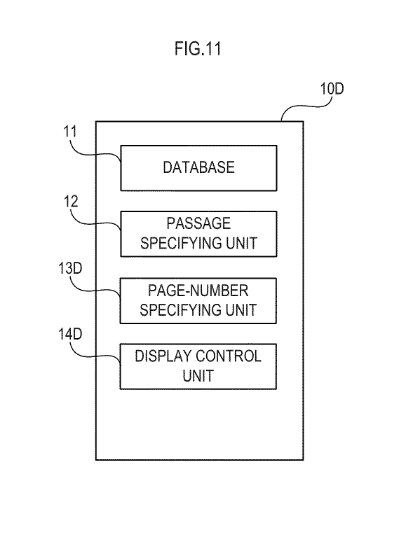

FIG. 11 is a block diagram showing a configuration of a server device 10D as an example of the server device 10. In the example, the server device 10D includes at least the database (storage unit) 11, the passage specifying unit 12, a page-number specifying unit 13D and a display control unit 14D.

The page-number specifying unit 13D specifies a page number of a page of the paper book in which display information designated by the user through the operating portion of the terminal 20 in the display information of the electronic book displayed on the display portion 300 is written. The display control unit 14D displays the passage and the like on the display portion 300 based on electronic book data. The display control unit 14D also displays the passage and the like corresponding to part of the electronic book data extracted by the passage specifying unit 12 on the display portion 300. The display control unit 14D further displays the page number of the paper book specified by the page-number specifying unit 13D on the display portion 300.

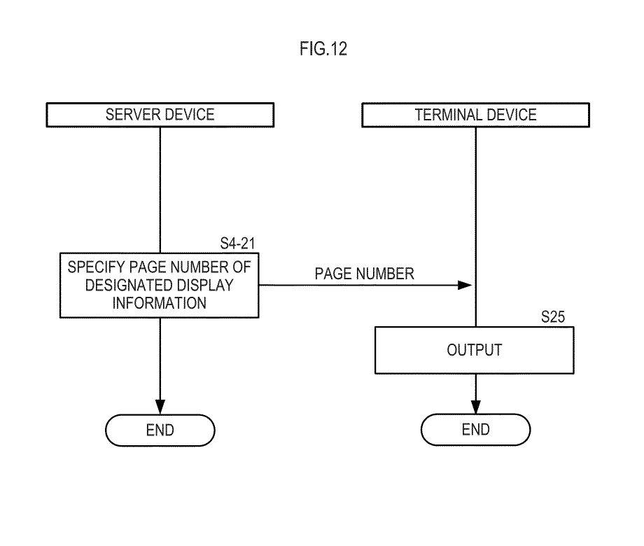

FIG. 12 is a flowchart showing an example of display processing executed by the system 100. In the display processing in the example, processing for specifying the page number of the page of the paper book is performed, in which display information (designated display information) designated by the user is written in the display information of the electronic book displayed on the display portion 300 of the terminal 20. Hereinafter, operations of the server device 10D and the terminal 20 will be explained as an example. Note that flowcharts showing respective operations of the server device 10D and the terminal 20 are not shown from the viewpoint of avoiding repeated explanation.

The display processing of the example is started, for example, when the server device 10D receives a request for the page number of the paper book and the designated display information from the terminal 20.

The server device 10D reads the page information of the electronic book (electronic book ID) corresponding to the received designated display information from the database 11 and specifies the page number of the page of the paper book in which the designated display information is written (Step S4-21). On the other hand, the terminal 20 receives information of the page number from the server device 10D and displays the page number on the display portion 300 (Step S25).

As the server device 10D includes the database 11, the passage specifying unit 12, the page-number specifying unit 13D and the display control unit 14D as an aspect of the fourth embodiment as described above, it is possible to figure out the page number of the paper book corresponding to the content of the electronic book displayed on the display portion 300 by the simple operation of the user. In addition to the above, the page number of the paper book can be figured out more accurately as the page number corresponding to the display information designated by the user is displayed.

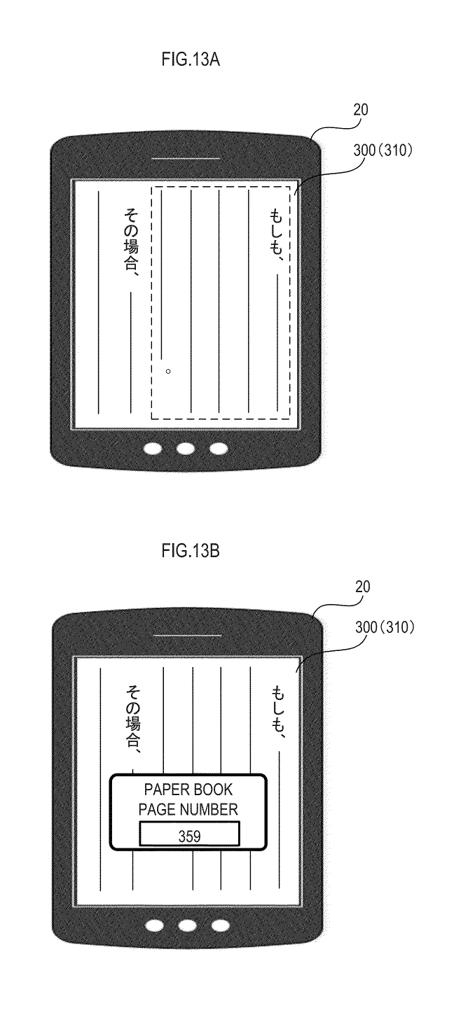

The designated display information in the above example of the fourth embodiment is, for example, text data of one sentence. The user designates one sentence from the passage displayed on the display portion 300 by performing a touch operation as shown in FIG. 13A. When the user performs the touch operation on a dashed-line area shown in FIG. 13A, the terminal 20 extracts text data of one sentence in the dashed-line area from the data for display based on the position of the touch operation as designated display information. Then, the terminal 20 transmits the request of the page number of the paper book and the designated display information to the server device 10D as described above. After that, the terminal 20 displays the page number of the paper book received from the server device 10D on the display portion 300 as shown in FIG. 13B. The start and the end of one sentence can be specified based on a period and so on indicating the end of the sentence. It is also preferable to designate a character string, not the whole sentence, as part of one sentence as designated display information. The designated display information is not limited to the above as long as information is displayed on the display portion 300. The dashed line shown in FIG. 13A is displayed for convenience of explanation, which is not actually displayed.

Additionally, the case where the server device 10D has various functions has been explained in the above example of the fourth embodiment, however, it is also preferable that the user terminal (for example, the terminal 20), not the server device, has part or all of various functions included in the server device 10D.

### Fifth Embodiment

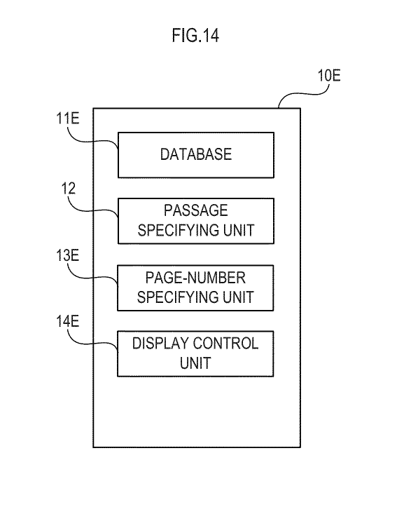

FIG. 14 is a block diagram showing a configuration of a server device 10E as an example of the server device 10. In the example, the server device 10E includes at least a database (storage unit) 11E, the passage specifying unit 12, a page-number specifying unit 13E and a display control unit 14E.

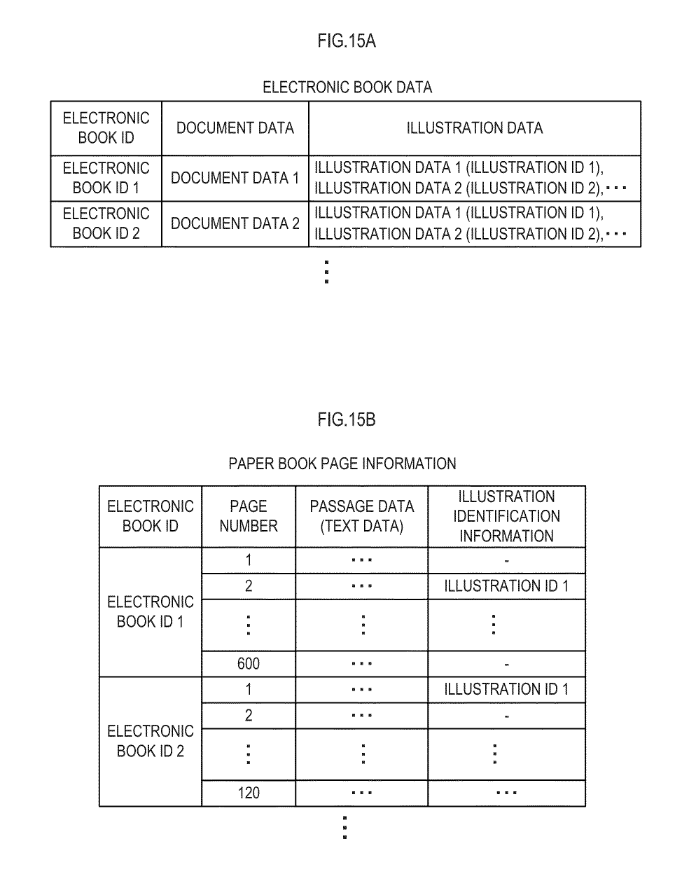

The database 11E stores electronic book data including illustration data (image data) and page information including identification information of the illustration data as shown in FIG. 15A and FIG. 15B. Document data includes position information in which illustration data is written (inserted) and the identification information of the illustration data to be inserted. The identification information of the illustration data is information for specifying illustration data, which is, for example, a file name of the illustration data. In the page information, a page number of a page of the paper book in which an illustration is written is stored so as to be associated with the identification information of corresponding illustration data. That is, the page information corresponds to illustration position information indicating position information of an illustration in the paper book.

The page-number specifying unit 13E specifies a page number of a page of the paper book in which an illustration designated by the user is written in display information of the electronic book displayed on the display portion 300 by using the operating portion of the terminal 20. The display control unit 14E displays the passage and the like on the display portion 300 based on the electronic book data. The display control unit 14E also displays the passage and the like corresponding to part of the electronic book data extracted by the passage specifying unit 12 on the display portion 300. The display control unit 14E further displays the page number of the paper book specified by the page-number specifying unit 13E on the display portion 300.

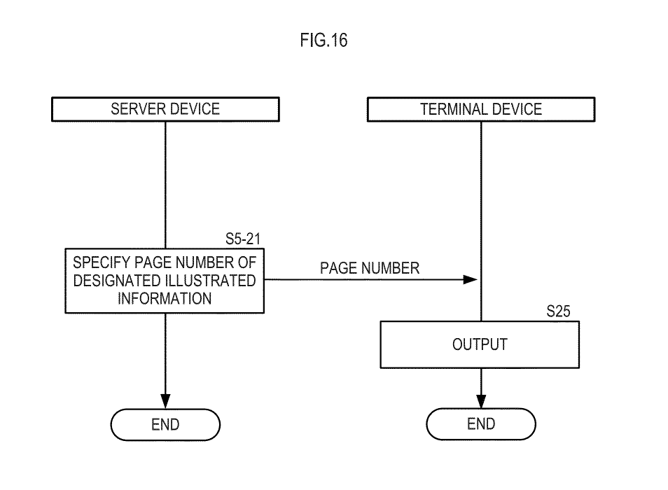

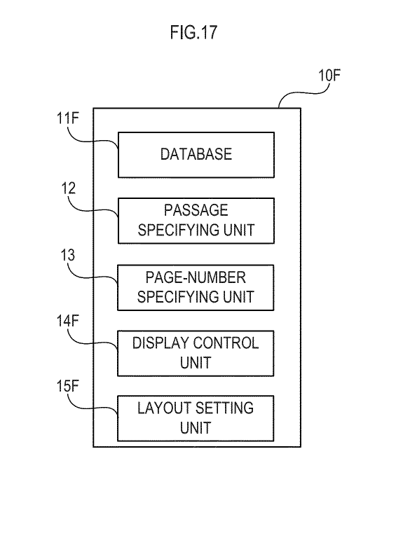

FIG. 16 is a flowchart showing an example of display processing executed by the system 100. In the display processing in the example, processing for specifying the page number of the page of the paper book is performed, in which the illustration data corresponding to the illustration (designated illustration information) designated by the user is written in the display information of the electronic book displayed on the display portion 300 of the terminal 20. Hereinafter, operations of the server device 10E and the terminal 20 will be explained as an example. Note that flowcharts showing respective operations of the server device 10E and the terminal 20 are not shown from the viewpoint of avoiding repeated explanation.

The display processing of the example is started, for example, when the server device 10E receives a request for the page number of the page of the paper book and the designated illustration information from the terminal 20.

The server device 10E reads the page information of the electronic book (electronic book ID) corresponding to the received designated illustration information from the database 11E and specifies the page number of the page of the paper book in which the illustration data corresponding to the designated illustration information is written (Step S5-21). The designated illustration information is, for example, the identification information of the illustration data. On the other hand, the terminal 20 receives information of the page number from the server device 10E and displays the page number on the display portion 300 (Step S25).

As the server device 10E includes the database 11E, the passage specifying unit 12, the page-number specifying unit 13E and the display control unit 14E as an aspect of the fifth embodiment as described above, it is possible to figure out the page number of the paper book corresponding to the content of the electronic book displayed on the display portion 300 by the simple operation of the user. In addition to the above, the page number of the paper book can be figured out more accurately as the page number of the paper book corresponding to the display information (designated illustration information) designated by the user is displayed.

Additionally, the case where the server device 10E has various functions has been explained in the above example of the fifth embodiment, however, it is also preferable that the user terminal (for example, the terminal 20), not the server device, has part or all of various functions included in the server device 10E.

### Sixth Embodiment

FIG. 17 is a block diagram showing a configuration of a server device 10F as an example of the server device 10. In the example, the server device 10F includes at least a database (storage unit) 11F, the passage specifying unit 12, the page-number specifying unit 13, a display control unit 14F and a layout setting unit 15F.

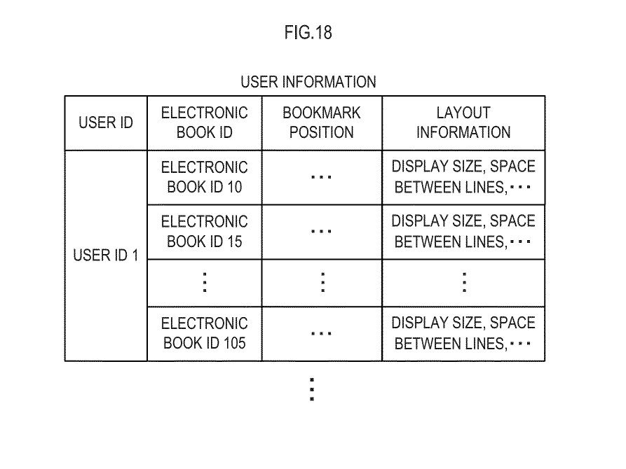

The database 11F stores user information of each user (user ID) as shown in FIG. 18 in addition to the electronic book data and the page information. The user ID is unique identification information given to each user. FIG. 18 is an explanatory view for explaining user information. The user information is information concerning electronic books and so on which can be browsed by the user. The user information includes electronic book IDs, bookmark information, layout information and the like which are associated with the user ID. The electronic book IDs specify electronic books which can be browsed. For example, the electronic ID of the electronic book purchased by the user is registered in the user information. The electronic book ID is also associated with the bookmark information and the layout information.

The bookmark information is position information designated by the user in a corresponding electronic book (electronic book ID). That is, the bookmark information is information for specifying a half-read position (interrupted position) of the electronic book of the user. In the bookmark position, for example, one sentence (text data) designated by the user through the operating portion is set.

The layout information is information for designating a display state (display format) of the electronic book on the display portion 300. The layout information includes information such as a display size (font size) of characters and a space between lines forming the passage to be displayed on the display portion 300 of the terminal 20. The information of the display size and the space between lines can be the magnification with respect to default values.

The layout information can be set by the user operating the operating portion of the terminal 20. For example, when the user inputs the display size and the like by operating the touch panel device of the terminal 20, the terminal 20 transmits layout information such as the display size and so on received by the user's input to the server device 10F with the user ID and the electronic book ID. The server device 10F (layout setting unit 15F) updates (changes) layout information of the user information corresponding to the user ID based on the received layout information.

The display control unit 14F displays the passage and the like on the display portion 300 based on the electronic book data with the set display size. The display control unit 14F displays the passage and the like corresponding to part of the electronic book data extracted by the passage specifying unit 12 on the display portion 300 with the set display size. The display control unit 14F displays the page number of the paper book specified by the page number specifying portion 13 on the display portion 300.

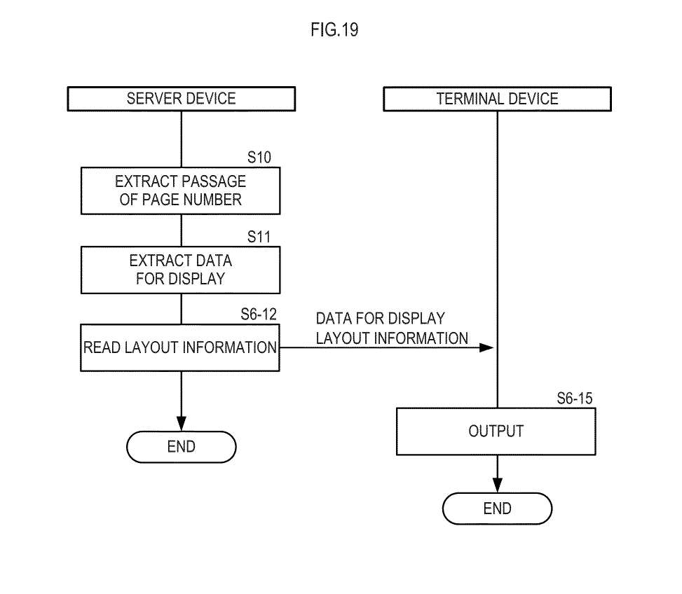

FIG. 19 is a flowchart showing an example of display processing executed by the system 100. In the display processing in the example, when the user designates a page number of the paper book, processing for displaying the passage of the paper book corresponding to the page number on the display portion 300 based on the layout information is performed. Hereinafter, the case where the display processing is executed by the server device 10F and the terminal 20 will be explained as an example. Note that flowcharts showing respective operations of the server device 10F and the terminal 20 are not shown from the viewpoint of avoiding repeated explanation.

The display processing of the example is started, for example, when the server device 10F receives information of the page number of the paper book designated by the user including the user ID of the user and the electronic book ID of the electronic book corresponding to the paper book from the terminal 20.

In the display processing, the server device 10F reads the page information of the electronic book (electronic book ID) corresponding to the paper book from the database 11F and extracts the passage corresponding to the page number designated by the user (Step S10). Next, the server device 10F reads the electronic book data corresponding to the electronic book ID from the database 11F and extracts data (the data for display) corresponding to the passage extracted in Step S10 from the electronic book data (Step S11). Next, the server device 10F reads the layout information corresponding to the user ID and the electronic book ID from the database 11F (Step S6-12).

On the other hand, the terminal 20 receives the data for display and the layout information from the server device 10F and displays the passage of the electronic book on the display portion 300 based on the data for display in accordance with the display size and the like of the layout information (Step S6-15). There is a case where it is difficult to display the entire passage included in the data for display according to the display size of characters. In such case, the passage may be displayed in the possible range from the first sentence included in the data for display.

As the server device 10F includes the database 11F, the passage specifying unit 12, the page-number specifying unit 13, the display control unit 14F and the layout setting unit 15F as an aspect of the sixth embodiment as described above, it is possible to display the passage corresponding to the page number of the paper book on the display portion 300 by the simple operation by the user in accordance with layout information set by the user. Therefore, for example, the user who is reading both the electronic book and the paper book having the same content can restart the reading in the electronic book from a place where the reading is stopped in the paper book without setting the display state each time the user browses the electronic book easily.

The layout information in the above example of the six embodiment is not limited to the above-described display size of characters and the like. The layout information may be, for example, a display color of characters. It is also possible that layout information which can be set by the user is limited to the display size, and that fixed information is allowed to be included in the electronic book data concerning other layout information.

Additionally, the case where the server device 10F has various functions has been explained in the above example of the sixth embodiment, however, it is also preferable that the user terminal (for example, the terminal 20), not the server device, has part or all of various functions included in the server device 10F.

### Seventh Embodiment

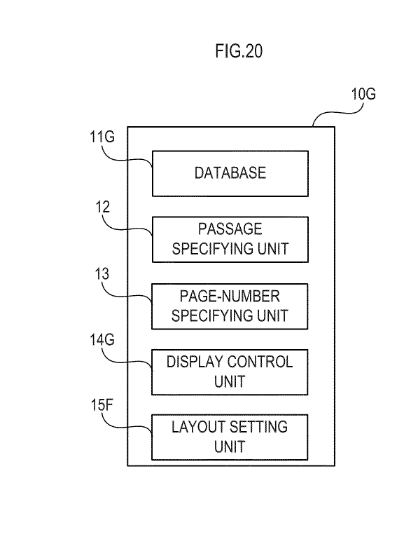

FIG. 20 is a block diagram showing a configuration of a server device 10G as an example of the server device 10. In the example, the server device 10G includes at least a database (storage unit) 11G, the passage specifying unit 12, the page-number specifying unit 13, a display control unit 14G and the layout setting unit 15F.

The database 11G stores the user information of each user in addition to the electronic book data and the page information in the same manner as the sixth embodiment. The display control unit 14G displays the passage and the like on the display portion 300 based on the electronic book data in accordance with the set layout information. The display control unit 14G also displays the passage and the like corresponding to part of the electronic book data extracted by the passage specifying unit 12 on the display portion 300 in accordance with the set layout information. More specifically, the display control unit 14G displays the entire content of the passage and the like corresponding to part of the extracted electronic book data on the display portion 300, then, displays the passage designated by the user from the passage displayed on the display portion 300 through the operating portion in accordance with the set layout information on the display portion 300.

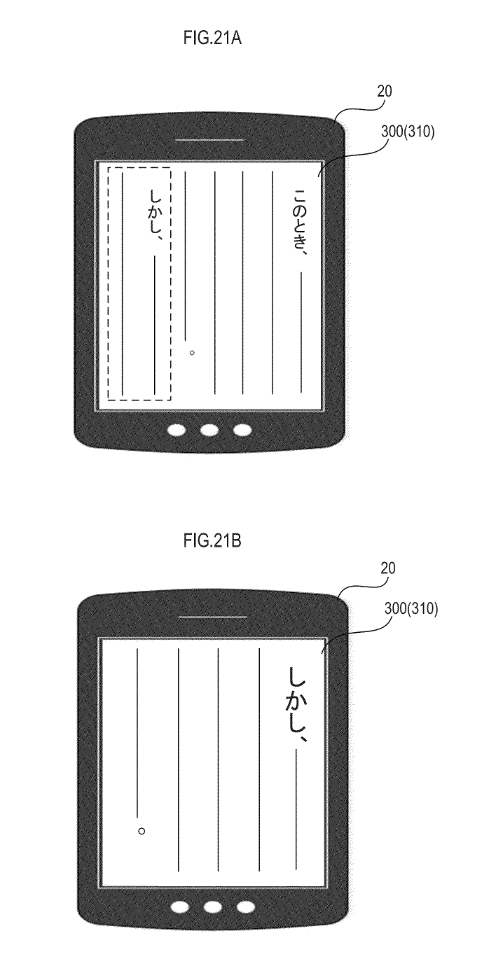

For example, when the user designates a page number of the paper book, the entire content of the passage and the like written in the page of the paper book corresponding to the designated page number is displayed on the display portion 300 as shown in FIG. 21A. Then, when the passage inside a dashed line is selected by performing a touch operation of a dashed-line area shown in FIG. 21A, the passage and so on started from the selected passage is displayed on the display portion 300 in accordance with the set layout information as shown in FIG. 21B. FIGS. 21A and 21B are views showing an example of the passage of the electronic book displayed on the display portion 300 of the terminal 20. The dashed line shown in FIG. 21A is displayed for convenience of explanation, which is not actually displayed.

The display control unit 14G also displays the page number of the paper book specified by the page-number specifying unit 13 on the display portion 300.

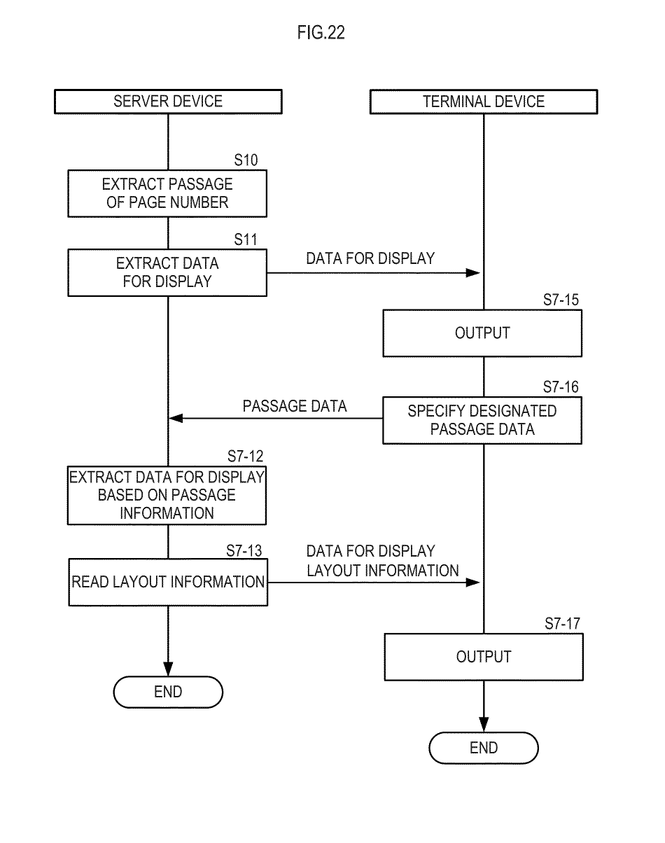

FIG. 22 is a flowchart showing an example of display processing executed by the system 100. In the display processing in the example, when the user designates a page number of the paper book, processing for displaying the passage selected by the user from passages of the electronic book corresponding to the page number on the display portion 300 in accordance with layout information is performed. Hereinafter, the case where the display processing is executed by the server device 10G and the terminal 20 will be explained as an example. Note that flowcharts showing respective operations of the server device 10G and the terminal 20 are not shown from the viewpoint of avoiding repeated explanation.

The display processing of the example is started, for example, when the server device 10G receives information of the page number of the paper book designated by the user including the user ID of the user and the electronic book ID of the electronic book corresponding to the paper book from the terminal 20.

In the display processing, the server device 10G reads the page information of the electronic book (electronic book ID) corresponding to the paper book from the database 11G and extracts the passage corresponding to the page number designated by the user (Step S10). Next, the server device 10G reads the electronic book data corresponding to the electronic book ID from the database 11G and extracts data (the data for display) corresponding to the passage extracted in Step S10 from the electronic book data (Step S11).

On the other hand, the terminal 20 receives the data for display from the server device 10G and displays the entire passage of the electronic book based on the data for display on the display portion 300 (Step S7-15). Concerning the display state for displaying the entire passage on the display portion 300, for example, the data can be received from the server 10G as well as given layout information may be stored in the terminal 20 side. For example, the display size may be the smallest as long as the entire content of the passage and the like of the data for display can be displayed. Next, the terminal 20 specifies passage information (text data) selected (designated) by the user from the passage displayed on the display portion 300 based on the touch position and the like (Step S7-16).

The server device 10G extracts data (the data for display) started from the corresponding passage from the electronic book data based on the passage information designated by the terminal 20 (Step S7-12). For example, data (the data for display) corresponding to a given amount of the passage including the passage designated by the user in the electronic book data is extracted. Next, the server device 10G reads the layout information corresponding to the user ID and the electronic book ID from the database 11G (Step S7-13).

On the other hand, the terminal 20 receives the data for display and layout information from the server device 10G and displays the passage of the electronic book based on the data for display on the display portion 300 in accordance with the layout information (Step S7-17).

As the server device 10G includes the database 11G, the passage specifying unit 12, the page-number specifying unit 13 and the display control unit 14G and the layout setting unit 15F as an aspect of the seventh embodiment as described above, it is possible to display the passage corresponding to the page number of the paper book on the display portion 300 by the simple operation by the user in accordance with layout information set by the user. It is also possible to display the passage written in the page of the page number of the paper book so as to include at least the passage designated by the user. Although there is a case where a part desired to be read is not displayed from the beginning even when the page number is designated when the set display size of characters is large, the display can be performed so that at least the passage designated by the user is included in the embodiment, therefore, the user who is reading both the electronic book and the paper book having the same content can easily restart the reading in the electronic book from a place where the reading is stopped in the paper book easily.

Additionally, the case where the server device 10G has various functions has been explained in the above example of the seventh embodiment, however, it is also preferable that the user terminal (for example, the terminal 20), not the server device, has part or all of various functions included in the server device 10G.

### Eight Embodiment

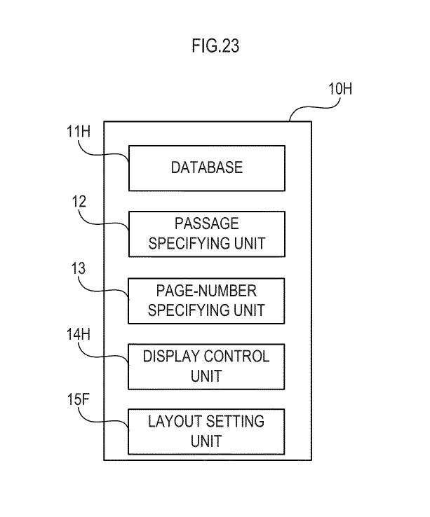

FIG. 23 is a block diagram showing a configuration of a server device 10H as an example of the server device 10. In the example, the server device 10H includes at least a database (storage unit) 11H, the passage specifying unit 12, the page-number specifying unit 13, a display control unit 14H and the layout setting unit 15F.

The database 11H stores electronic book data including illustration data (image data) in the same manner as the database 11E of the fifth embodiment. The document data also includes position information in which illustration data is written (inserted) and identification information of the illustration data to be inserted also in the same manner as the fifth embodiment. Additionally, the database 11H stores user information of each user in the same manner as the sixth embodiment.

The display control unit 14H displays the passage and the like on the display portion 300 based on the electronic book data. The display control unit 14H also displays the passage and the like corresponding to part of the electronic book data extracted by the passage specifying unit 12 on the display portion 300. The display control unit 14H further displays a page number of the paper book specified by the page number specifying unit 13 on the display portion 300.

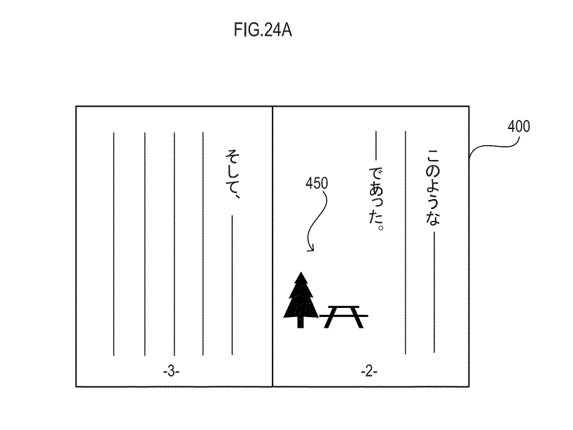

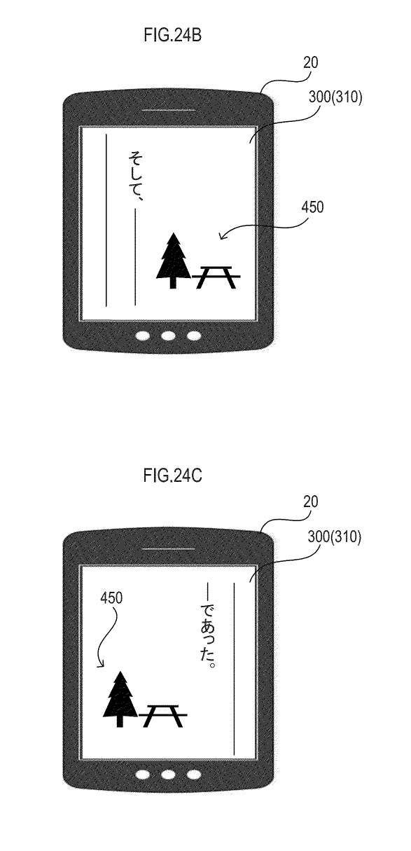

When the display control unit 14H displays the passage and the like on the display portion 300 based on the electronic book data, the display control unit 14H also displays the illustration. The display control unit 14H controls (adjusts) a space between lines so that the illustration is displayed together with the passage written in the page including the illustration in the paper book. For example, when an illustration 450 is written with the passage on a page 2 of a paper book 400 as shown in FIG. 24A, there is a case where the passage and the illustration 450 written in the same page in the paper book 400 are displayed in a divided state according to the display size of characters and so on in the electronic book as shown in FIG. 24B. In this case, the display control unit 14H changes the setting of a space between lines so that at least part of the passage and the illustration 450 written in the same page of the paper book 400 are displayed on the display portion 300 at the same time (processing of setting the space between lines) as shown in FIG. 24C.

The determination whether the illustration and the passage in the same page in the paper book are displayed on the display portion 300 separately or not is performed by using setting values of the display size of characters and the space between lines and pixel information (horizontal dot×vertical dot) of the display area of the electronic book on the display portion 300. The display size of characters and the space between lines are included in the layout information of the user information. The pixel information of the display area is acquired from the terminal 20. It is possible to calculate the number of rows and the number of characters per one row which can be displayed in the display area based on these information. It is also possible to acquire pixel information of the illustration image from the illustration data and also calculate pixel information necessary to display the illustration. As a calculation method itself is a common technique, the detailed explanation is omitted.

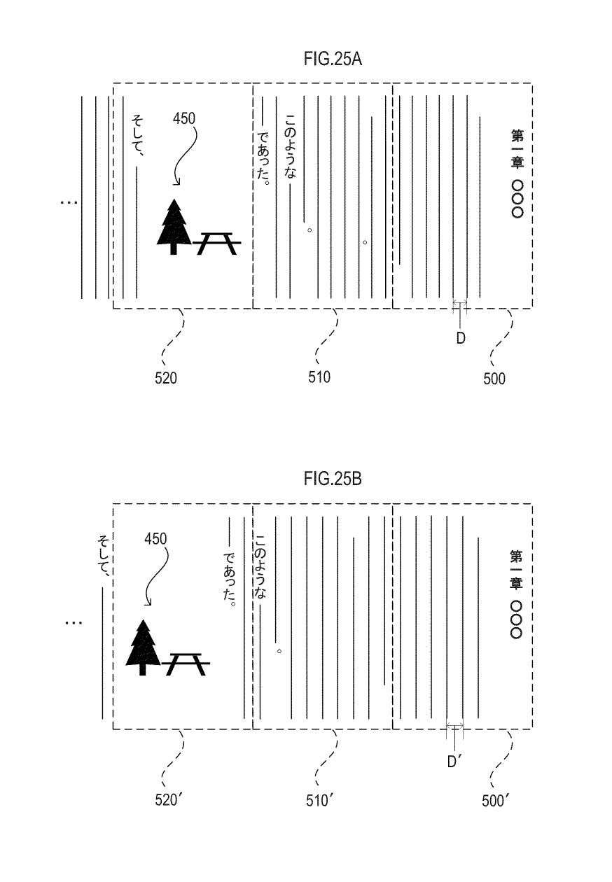

Next, the processing of setting the space between lines will be specifically explained with reference to FIGS. 25A and 25B. FIGS. 25A and 25B show a state where the passage from the top to the middle and the illustration 450 in the electronic book which correspond to the paper book 400 cited in FIG. 24A are displayed on the display portion 300. Each of dashed-line areas 500′, 510′, 520′ in FIG. 25B indicates display information of one screen in the display portion 300. When the user starts browsing the electronic book, display information of the dashed line area 500′ is displayed on the display portion 300 first. Next, display information of the dashed-line area 510′ is displayed.

FIG. 25A shows a state where the passage and the like of the electronic book are displayed based on the layout information of user information. That is, FIG. 25A shows the display state where the processing of setting the space between lines is not executed. A state where a setting value D as a space between lines shown in FIG. 25A has been changed to a setting value D′ by the processing of setting the space between lines is shown in FIG. 25B.

In the processing of setting the space between lines, for example, in a range from one sentence at the head (reference position) of the electronic book to the illustration 450 displayed first as shown in FIG. 25A, whether the illustration 450 is displayed on the display portion 300 with the passage in the same page of the paper book or not is determined by using information of the display size and so on. Specifically, the passage with which the illustration is displayed on the display portion 300 is specified based on the space between lines (given value) at present and setting values of the display size and so on. That is, in the range from the head passage to the illustration 450 in the electronic book, display parts (dashed-line areas 500, 510 and 520) in one screen (page) to be displayed on the display portion 300 are specified as shown in FIG. 25A.

Then, whether the passage with which the illustration 450 is displayed on the display portion 300 (the passage of the dashed-line area 520) is part of the passage in the same page as the illustration 450 in the paper book or not is determined based on the page information. When it is determined that the passage is not one in the same page, the setting value of the space between lines is changed. For example, a value of correction is added to the current setting value of the space between lines. The passage displayed with the illustration 450 shown in FIG. 25A is not the same as the passage of the same page as compared with FIG. 24A, therefore, it is determined that the passage is not one in the same page, and the setting value D as the space between lines is changed to the setting value D′.

Then, whether the passage with which the illustration 450 is displayed on the display portion 300 is part of the passage in the same page as the illustration in the paper book or not is determined again. As shown in FIG. 25B, the passage with which the illustration 450 is displayed on the display portion 300 (the passage of the dashed-line area 520′) is part of the passage in the same page as the illustration 450 in the paper book, therefore, the current setting value of the space between lines is maintained. Then, the layout information including the setting value of the space between lines is transmitted to the terminal 20 with data for display, and the passage of the electronic book is displayed on the display portion 300.

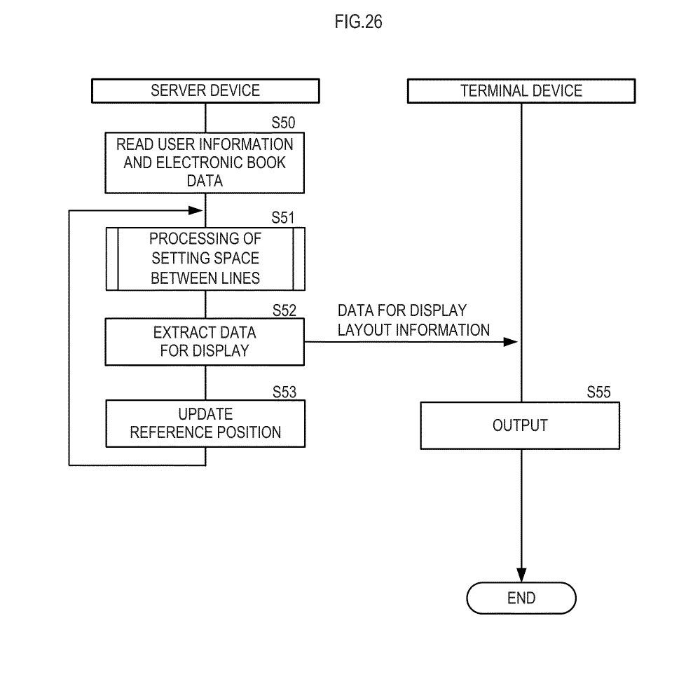

FIG. 26 is a flowchart showing an example of display processing executed by the system 100. In the display processing in the example, processing for displaying the passage and the like of the electronic book browsed by the user on the display portion 300 is performed. Hereinafter, the case where the display processing is executed by the server device 10H and the terminal 20 will be explained as an example. Note that flowcharts showing respective operations of the server device 10H and the terminal 20 are not shown from the viewpoint of avoiding repeated explanation.

The display processing of the example is started, for example, when the server device 10H receives the browsing request of the electronic book from the terminal 20 with the user ID, the electronic ID and the pixel information of the display area of the electronic book. More specifically, when the user makes the browsing request by performing a touch operation (selecting) the icon image of the electronic book displayed on the display potion 300, the browsing request is transmitted from the terminal 20 to the server device 10H.

In the display processing, the server device 10H reads the user information and the electronic book data based on the user ID and the electronic book ID (Step S50), executing the processing of setting the space between lines (Step S51). In the processing of setting the space between lines, the space between lines is set so that part of the passage and the illustration written in the same page of the paper book corresponding to the electronic book are displayed as described above.

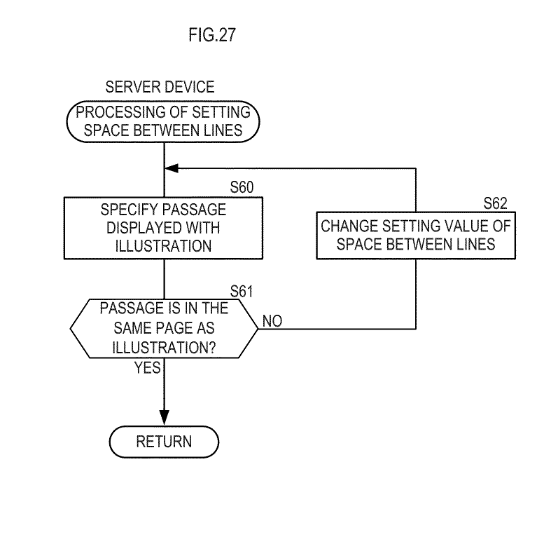

FIG. 27 is a flowchart showing an example of the processing of setting the space between lines in Step S51. The server device 10H specifies the passage with which the illustration displayed first from the reference position is displayed on the display portion 300 based on the space between lines, the display size of characters, pixel information of the display area and the like as described above (Step S60). Here, the reference position corresponds to a sentence set as the bookmark position included in the user information. When the electronic book is browsed first, the first (head) sentence of the electronic book is set at the bookmark position as an initial setting value.

Next, the server device 10H determines whether the specified passage is part of the passage in the same page as the illustration in the paper book or not based on the page information corresponding to the electronic book (Step S61). When the passage is not part of the same page (NO: Step S61), the server device 10H changes the current setting value of the space between lines in the user information (layout information) (Step S62). For example, the server device 10H adds a correction value to the current setting value as described above. After that, the server device 10H returns to the processing of Step S60, repeatedly performing the above processing until the passage becomes part of the passage of the same page (YES: Step S61).

When the passage is part of the passage in the same page (YES: Step S61), the server device 10H ends the processing of setting the space between lines and proceeds to Step S52. Next, the server device 10H extracts data (the data for display) from the reference position to the first illustration from the electronic book data (Step S52). Then, the server device 10H sequentially transmits the data for display with the layout information to the terminal 20. After that, the server device 10H updates the reference position (Step S53), repeatedly executing the processing of Steps S51 to S53 until the browsing of the electronic book is completed. As the update of the reference position, for example, a sentence continued from the passage displayed with the illustration on the display portion 300 is set.

As the server device 10H includes the database 11H, the passage specifying unit 12, the page-number specifying unit 13 and the display control unit 14H and the layout setting unit 15F as an aspect of the eight embodiment as described above, the display state closer to the paper book corresponding to the electronic book can be realized in accordance with environment in which the electronic book of the display size of characters, the size (pixel information) of the display area and so on is displayed.

In the above example of the eight embodiment, the processing of setting the space between lines can be applied also when the user designates the page number of the paper book to display the passage of the corresponding electronic book.

Additionally, the case where the server device 10H has various functions has been explained in the above example of the eighth embodiment, however, it is also preferable that the user terminal (for example, the terminal 20), not the server device, has part or all of various functions included in the server device 10H.

### Ninth Embodiment

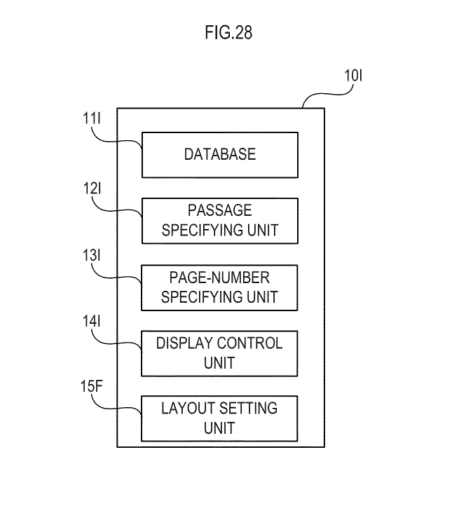

FIG. 28 is a block diagram showing a configuration of a server device 10I as an example of the server device 10. In the example, the server device 10I includes at least a database (storage unit) 11I, a passage specifying unit 12I, a page-number specifying unit 13I, a display control unit 14I and the layout setting unit 15F.

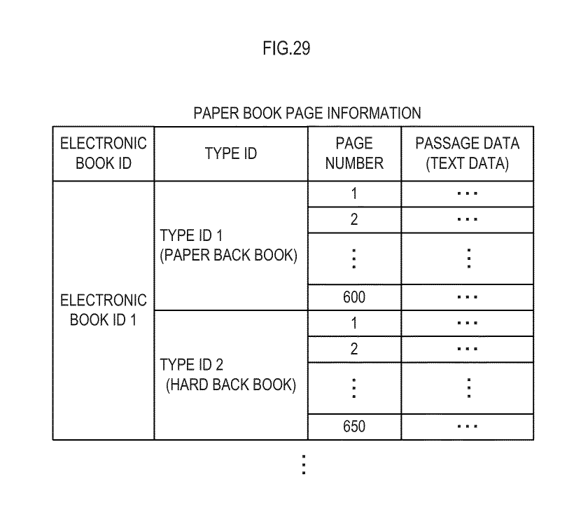

The database 11I stores plural electronic book data, paper book page information (page information) and the like. The electronic book data is the same as those in other embodiments. The page information includes information corresponding to plural types of paper books having the same content. In the embodiment, the page information of two types of the paper books which are a hardback book and a paperback book having the same content will be described. The page information includes type IDs associated with an electronic book ID, page information and text information as shown in FIG. 29. The type ID is identification information for specifying the type of the paper book. The page information and the text information are the same as those in other embodiments, however, they are associated with respective type IDs.

The passage specifying unit 12I extracts part of the electronic book data (corresponding to the document data and so on) corresponding to a passage written in a page of the paper book corresponding to the page number designated by the user through the terminal 20 and the type of the paper book based on the page information. The page-number specifying unit 13I specifies the page number of the page of the paper book in which display information of the electronic book displayed on the display portion 300 of the terminal 20 is written from the electronic book data. At this time, the page-number specifying unit 13I specifies the page number of the paper book corresponding to the type designated by the user. The display control unit 14I displays the passage and the like corresponding to part of the electronic book data extracted by the passage specifying unit 12I on the display portion 300. The display control unit 14I further displays the page number of the paper book specified by the page-number specifying unit 13I on the display portion 300.

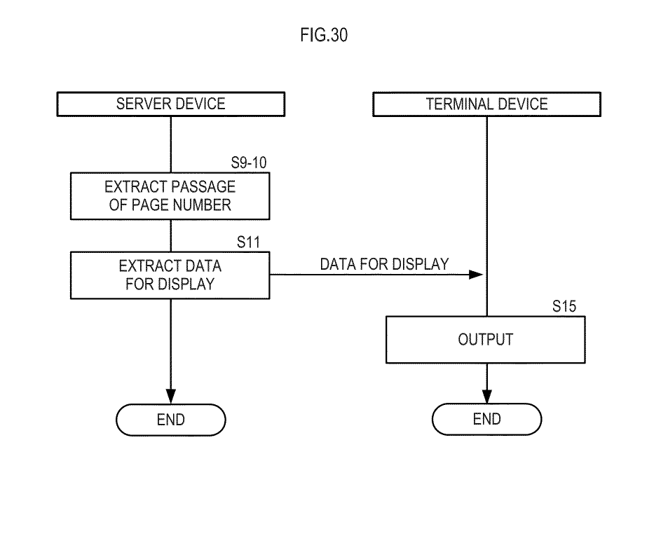

FIG. 30 is a flowchart showing an example of display processing executed by the system 100. In the display processing in the example, when the user designates a page number of the paper book and a type of the paper book, processing for displaying the passage of the electronic book corresponding to the page number on the display portion 300 is performed. Hereinafter, the case where the display processing is executed by the server device 10I and the terminal 20 will be explained as an example. Note that flowcharts showing respective operations of the server device 10I and the terminal 20 are not shown from the viewpoint of avoiding repeated explanation.

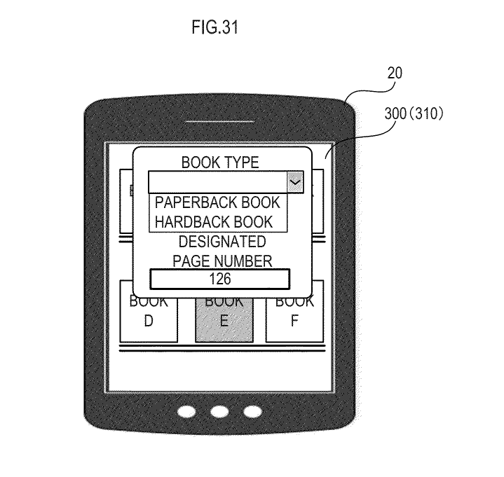

The display processing of the example is started, for example, when the server device 10I receives information of the page number and the type (type ID) of the paper book designated by the user through the terminal 20 including the electronic book ID and the like of the electronic book corresponding to the paper book. Specifically, the user selects (touch operation) an icon image of an electronic book desired to be browsed in a state where an image shown in FIG. 31 is displayed on the display portion 300 to designate the type of the paper book on a small window (to select the paperback book or the hardback book by a pull-down menu) and to designate the page number by a touch operation of a software keyboard (not shown). FIG. 31 shows a state where an electronic book E is selected. After the designation, the above information such as the page number is transmitted from the terminal 20 to the server device 10I by performing a touch operation of a determination key (not shown).

Electronic books A to F shown in FIG. 31 correspond to electronic book IDs included in the user information. For example, when a display request for a list of electronic books purchased by the user is received from the terminal 20, data for display is transmitted from the server device 10I to the terminal 20.

Returning to FIG. 30, the server device 10I reads the page information corresponding to the electronic book (electronic book ID) which corresponds to the paper book and the type ID from the database 11I and extracts the passage corresponding to the page number designated by the user in display processing (Step S9-10). Next, the server device 10I reads the electronic book data corresponding to the electronic book ID and extracts data (the data for display) corresponding to the passage extracted in Step S9-10 from the electronic book data (Step S11).

On the other hand, the terminal 20 receives the data for display from the server device 10I, displaying the passage of the electronic book based on the data for display on the display portion 300 (Step S15).

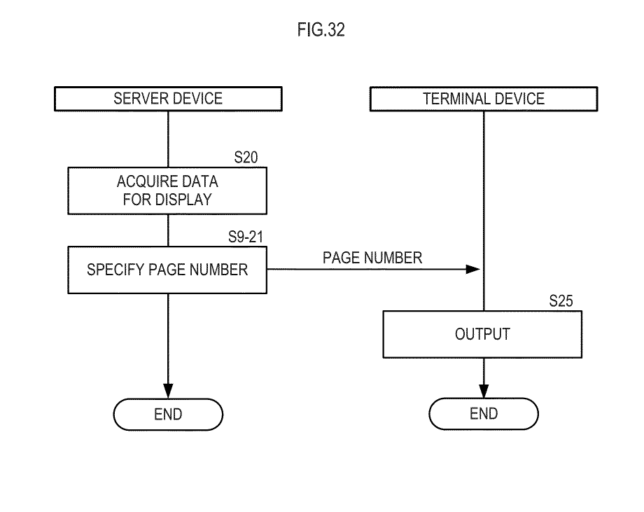

FIG. 32 is a flowchart showing an example of display processing executed by the system 100. In the display processing in the example, processing for specifying the page number of the page of the paper book in which display information of the electronic book displayed on the display portion 300 of the terminal 20 is written is performed. Hereinafter, operations of the server device 10I and the terminal 20 will be explained as an example. Note that flowcharts showing respective operations of the server device 10I and the terminal 20 are not shown from the viewpoint of avoiding repeated explanation.

The display processing of the example is started, for example, when the server device 10I receives a request for the page number of the paper book with the type ID of the paper book from the terminal 20. Specifically, the user selects (touch operation) the electronic book in the state where icon images of electronic books shown in FIG. 31 are displayed on the display portion 300 and designates the type of the paper book by a touch operation, then, the user performs an operation of requesting the page number of the paper book, thereby transmitting the information such as the type ID from the terminal 20 to the server device 10I.

In the above display processing, the server device 10I acquires the display information (data for display) displayed on the display portion 300 at present from the electronic book data (Step S20). Next, the server device 10I reads the page information of the electronic book (electronic book ID) corresponding to the type ID and the data for display from the database 11 and specifies the page number of the page of the paper book in which the display information of the electronic book is included (Step S9-21).

On the other hand, the terminal 20 receives information of the page number from the server device 10I and displays the page number on the display portion 300 (Step S25).

As the server device 10I includes the database 11I, the passage specifying unit 12I, the page-number specifying unit 13I and the display control unit 14I and the layout setting unit 15F as an aspect of the ninth embodiment as described above, it is possible to display the passage corresponding to the page number of the paper book on the display portion 300 by the simple operation of the user in each type of the paper book. It is also possible to figure out the page number of the paper book corresponding to the content of the electronic book displayed on the display portion 300 by the simple operation in each type of the paper book. Therefore, the user friendliness is extremely high for the user, for example, who is reading both the electronic book and the paper book having the same content.

In the above example of the ninth embodiment, the designation of the page number and so on is performed concerning the electronic book selected from electronic books based on the user information, however, it is not limited to this. For example, it is possible to select the electronic book from electronic books which can be browsed in the system 100.

Also in the above example of the ninth embodiment, two types of paper books which are the hardback book and the paperback book have been explained, however, the types are not particularly limited to the above as long as types relate to paper books having the same content as the electronic book.

As described above, the electronic-book system 100 according to respective embodiments has extremely high user friendliness for the user reading both the electronic book and the paper book having the same content as compared with related-art systems. The configuration of the electronic-book system is completely different from, for example, that of the related-art system described in JP-A-2012-252453 having the configuration in which an electronic bookmark is fundamental.

### [Notes]

The above explanation of embodiments have been made so that the following inventions can be achieved at least by those ordinarily skilled in the art to which the invention belongs.

[1]

An electronic-book display processing program for allowing a computer to execute a function of displaying a passage of an electronic book which has the same content as a paper book on a display portion of a terminal device based on electronic book data including reflowable document data, which allows the computer to execute:

a passage specifying function which extracts part of the electronic book data including data corresponding to a passage written in a page of the paper book corresponding to a page number based on the page number of the paper book designated by the user through an operating portion of the terminal device from a storage unit storing the electronic book data so as to be associated with page numbers of the paper book,

a page-number specifying function which specifies a page number of a page of the paper book in which at least part of display information is written from the electronic book data based on the display information of the electronic book displayed on the display portion, and

a display control function which displays the passage on the display portion based on the electronic book data,

in which a passage corresponding to part of the extracted electronic book data is displayed on the display portion and the specified page number is displayed on the display portion in the display control function.

[2]

The electronic-book display processing program described in [1], which is for executing a function of specifying a page number of a page of the paper book in which display information designated by the user through the operating portion is written in display information of the electronic book displayed on the display portion in the page-number specifying function.

[3]

The electronic-book display processing program described in [2], in which the storage unit stores the electronic book data including illustration data and illustration position information including page numbers of pages of the paper book in which an illustration corresponding to the illustration data is written, which is for executing a function of specifying a page number of a page of the paper book in which the illustration designated by the user through the operating portion is written in display information of the electronic book displayed on the display portion in the page-number specifying function.

[4]

The electronic-book display processing program described in any of [1] to [3], which further allows the computer to execute:

a layout setting function which stores layout information having been inputted by the user through the operating portion concerning a display state of the electronic book on the display portion in the storage unit, which is for executing a function of displaying a passage corresponding to part of the extracted electronic book data on the display portion in accordance with the layout information in the display control function.

[5]

The electronic-book display processing program described in any of [1] to [3], which further allows the computer to execute:

a layout setting function which stores layout information having been inputted by the user through the operating portion concerning a display state of the electronic book on the display portion in the storage unit, which is for executing a function of displaying a passage designated by the user through the operating portion in passages displayed on the display portion in accordance with the layout information after the passages corresponding to part of the extracted electronic book data are displayed on the display portion in the display control function.

[6]

The electronic-book display processing program described in [4] or [5], in which the storage unit stores the electronic book data including illustration data and illustration position information including a page number of a page of the paper book in which an illustration corresponding to the illustration data is written, which is for executing, in the display control function,

a function of displaying an illustration on the display portion with a passage based on the illustration data and illustration position information,

a function of determining whether the illustration can be displayed with a passage written in a page of the paper book including the illustration or not based on the illustration position information at the time of displaying the passage on the display portion based on the layout information, and

a function of adjusting a space between lines included in the layout information and displaying the illustration with part of the passage written in the page of the paper book including the illustration when the illustration is not able to be displayed with the passage.

[7]

The electronic-book display processing program described in any of [1] to [6], in which electronic book data including document data of electronic books is stored so as to be associated with page numbers of plural types of paper books in the storage unit, which is for executing

a function of extracting part of the electronic book data including data corresponding to a passage written in a page of a paper book corresponding to a page number based on the type and the page number of the paper book designated by the user through the operating portion of the terminal device in the passage specifying function, and

a function of specifying a page number of the paper book in which part of display information is written from the electronic book data based on the type of the paper book designated by the user through the operating portion of the terminal device and the display information of the electronic book displayed on the display portion in the page-number specifying function.

[8]

A server device in which the electronic-book display processing program described in any of [1] to [7] is installed.

[9]

A program for allowing a terminal device to execute a function of displaying a document of an electronic book on a display portion, which allows the terminal device to execute a connecting function of connecting to the server device described in [8] through a communication network.

A terminal device in which the electronic-book display processing program described in any of [1] to [7] is installed.

An electronic-book display processing program for allowing a server device connected to a terminal device through a communication network, which has a display portion displaying a document of an electronic book which has the same content as a paper book based on electronic book data including document data of a reflowable format, to control the content of the electronic book to be displayed on the display portion, which allows the server device to execute:

a passage specifying function which extracts part of the electronic book data including data corresponding to a passage written in a page of the paper book corresponding to a page number based on the page number of the paper book designated by the user from a storage unit storing the electronic book data so as to be associated with page numbers of the paper book through an operating portion of the terminal device,

a page-number specifying function which specifies a page number of a page of the paper book in which at least part of display information from the electronic book data based on the display information of the electronic book displayed on the display portion, and

a display control function which displays the passage on the display portion based on the electronic book data,

in which the passage corresponding to part of the extracted electronic book data is displayed on the display portion and the specified page number is displayed on the display portion in the display control function.

[12]

The electronic-book display processing program described in [11] for executing a function of specifying a page number of a page of the paper book in which display information designated by the user through the operating portion is written in display information of the electronic book displayed on the display portion in the page-number specifying function.

[13 ]

The electronic-book display processing program described in [12], in which electronic book data including illustration data is stored and illustration position information including a page number of a page of the paper book in which an illustration corresponding to the illustration data is written is stored in the storage unit, which is for executing a function of specifying a page number of a page of the paper book in which an illustration designated by the user through the operating portion is written in display information of the electronic book displayed on the display portion in the page-number specifying function.

[14]

The electronic-book display processing program described in any of [11] to [13], which further allows the server device to execute:

a layout setting function which stores layout information having been inputted by the user through the operating portion concerning a display state of the electronic book on the display portion in the storage unit, which is for executing a function of displaying a passage corresponding to part of the extracted electronic book data on the display portion in accordance with the layout information in the display control function.

[15]

The electronic-book display processing program described in any of [11] to [13], which further allows the server device to execute:

a layout setting function which stores layout information having been inputted by the user through the operating portion concerning a display state of the electronic book on the display portion in the storage unit, which is for executing a function of displaying a passage designated by the user through the operating portion in the passages displayed on the display portion in accordance with the layout information after passages corresponding to part of the extracted electronic book data are displayed on the display portion in the display control function.

[16]

The electronic-book display processing program described in [14] or [15], in which electronic book data including illustration data is stored and illustration position information including a page number of a page of the paper book in which an illustration corresponding to the illustration data is written is stored in the storage unit, which is for executing, in the display control function,:

a function of displaying an illustration on the display portion with a passage based on the illustration data and illustration position information,

a function of determining whether the illustration can be displayed with a passage written in a page of the paper book including the illustration or not based on the illustration position information at the time of displaying the passage on the display portion based on the layout information, and

a function of adjusting a space between lines included in the layout information and displays the illustration with part of the passages written in the page of the paper book including the illustration when it is determined that the illustration is not able to be displayed with the passage.

[17]

The electronic-book display processing program described in any of [11] to [16], in which electronic book data including document data of electronic books is stored so as to be associated with page numbers of plural types of paper books in the storage unit, which is for executing

a function of extracting part of the electronic book data including data corresponding to a passage written in a page of a paper book corresponding to a page number based on the type and the page number of the paper book designated by the user through the operating portion of the terminal device in the passage specifying function, and

a function of specifying a page number of a page of the paper book in which part of display information is written from the electronic book data based on the type of the paper book designated by the user through the operating portion of the terminal device and the display information of the electronic book displayed on the display portion in the page-number specifying function.

[18]

An electronic-book system including a terminal device having a display means for displaying a document of an electronic book which has the same content as a paper book based on electronic book data including document data of a reflowable format and a server device connected to the terminal device through a communication network, which includes

a storage means for storing the electronic book data so as to be associated with page numbers of the paper book,

a passage specifying means for extracting part of the electronic book data including data corresponding to a passage written in a page of the paper book corresponding to a page number based on the page number of the paper book designated by the user from the storage means through an operating means of the terminal device,

a page-number specifying means for specifying a page number of a page of the paper book in which at least part of display information is written from the electronic book data based on the display information of the electronic book displayed on the display means, and

a display control means for displaying the document on the display means based on the electronic book data,

in which the display control means displays the passage corresponding to part of the extracted electronic book data on the display means and displays the specified page number on the display means.

[19]

The electronic-book system described in [18],

in which the page-number specifying means specifies a page number of a page of the paper book in which display information designated by the user through the operating means is written in display information of the electronic book displayed on the display means.

[20]

The electronic-book system described in [19],

in which the storage means stores electronic book data including illustration data and illustration position information including a page number of a page of the paper book in which an illustration corresponding to the illustration data is written, and

the page-number specifying means specifies a page number of a page of the paper page in which an illustration designated by the user through the operating portion is written in display information of the electronic book displayed on the display means.

[21]

The electronic-book system described in any of [19] to [20] further including:

a layout setting means for storing layout information having been inputted by the user through the operating portion concerning a display state of the electronic book on the display means in the storage unit,

in which the display control means displays a passage corresponding to part of the extracted electronic book data on the display means in accordance with the layout information.

[22]

The electronic-book system described in any of [19] to [20] further including:

a layout setting means for storing layout information having been inputted by the user through the operating portion concerning a display state of the electronic book on the display means in the storage means,

in which the display control means displays, after passages corresponding to part of the extracted electronic book data are displayed on the display means, a passage designated by the user through the operating means in the passages displayed on the display means in accordance with the layout information.

The electronic-book system described in [21] or [22],

in which the storage means stores electronic book data including illustration data and illustration position information including a page number of a page of the paper book in which an illustration corresponding to the illustration data is written is stored in the storage means,

the display control means displays an illustration on the display means with a passage based on the illustration data and illustration position information, determining whether the illustration can be displayed with a passage written in a page of the paper book including the illustration or not based on the illustration position information at the time of displaying the passage on the display means based on the layout information, and adjusting a space between lines included in the layout information and displaying the illustration with part of the passages written in the page of the paper book including the illustration when it is determined that the illustration is not able to be displayed with the passage.

[24]

The electronic-book system described in any of [18] to [23],

in which the storage means stores electronic book data including document data of electronic books so as to be associated with page numbers of plural types of paper books,

the passage specifying means extracts part of the electronic book data including data corresponding to a passage written in a page of a paper book corresponding to a page number based on the type and the page number of the paper book designated by the user through the operating means of the terminal device, and

the page-number specifying means specifies a page number of a page of the paper book in which part of display information is written from the electronic book data based on the type of the paper book designated by the user through the operating means of the terminal device and the display information of the electronic book displayed on the display means.

[25]

A terminal device having a display means for displaying a document of an electronic book which has the same content as a paper book based on electronic book data including document data of a reflowable format, which includes:

a storage means for storing the electronic book data so as to be associated with page numbers of the paper book,

an operating means receiving an operation input from the user,

a passage specifying means for extracting part of the electronic book data including data corresponding to a passage written in a page of the paper book corresponding to a page number based on the page number of the paper book designated by the user from the storage means through the operating means,

a page-number specifying means for specifying a page number of a page of the paper book in which at least part of display information is written from the electronic book data based on the display information of the electronic book displayed on the display means, and

a display control means for displaying the document on the display means based on the electronic book data,

in which the display control means displays the passage corresponding to part of the extracted electronic book data on the display means and displays the specified page number on the display means.

[26]

An electronic book display processing method for controlling the content of an electronic book to be displayed on a display portion by a server device connected to a terminal device through a communication network, which has the display portion displaying the document of the electronic book having the same content as the paper book based on electronic book data including document data of a reflowable format, which includes the steps of:

extracting part of the electronic book data including data corresponding to a passage written in a page of the paper book corresponding to a page number based on the page number of the paper book designated by the user from a storage unit storing the electronic book data so as to be associated with page numbers of the paper book through an operating portion of the terminal device,

specifying a page number of a page of the paper book in which at least part of display information is written from the electronic book data based on the display information of the electronic book displayed on the display portion and

displaying the document on the display portion based on the electronic book data by the server device,

in which the passage corresponding to part of the extracted electronic book data is displayed on the display portion and the specified page number is displayed on the display portion in the step of displaying the document on the display portion.

[27]

An electronic book display processing method executed by an electronic-book system, which includes a terminal device having a display means displaying a document of an electronic book having the same content as a paper book based on electronic book data including document data of a reflowable format and a server device connected to the terminal device through a communication network, including the steps of:

extracting part of the electronic book data including data corresponding to a passage written in a page of the paper book corresponding to a page number based on the page number of the paper book designated by the user from a storage unit storing the electronic book data so as to be associated with page numbers of the paper book through an operating portion of the terminal device,

specifying a page number of a page of the paper book in which at least part of display information is written from the electronic book data based on the display information of the electronic book displayed on the display portion and

displaying the document on the display portion based on the electronic book data by the electronic-book system,

in which the passage corresponding to part of the extracted electronic book data is displayed on the display portion and the specified page number is displayed on the display portion in the display control processing.

According to one of the embodiments of the present invention, it is useful to improve user friendliness at the time of reading both the electronic book and the paper book.

What is claimed is:

1. An electronic-book display processing program for allowing a computer to execute a function of displaying a passage of an electronic book which has the same content as a paper book on a display portion of a terminal device based on electronic book data including reflowable document data, which allows the computer to execute:
a passage specifying function which extracts part of the electronic book data including data corresponding to a passage written in a page of the paper book corresponding to a page number based on the page number of the paper book designated by the user through an operating portion of the terminal device from a storage unit storing the electronic book data so as to be associated with page numbers of the paper book,
a page-number specifying function which specifies a page number of a page of the paper book in which at least part of display information is written from the electronic book data based on the display information of the electronic book displayed on the display portion, and
a display control function which displays the passage on the display portion based on the electronic book data,
wherein a passage corresponding to part of the extracted electronic book data is displayed on the display portion and the specified page number is displayed on the display portion in the display control function.

2. The electronic-book display processing program according to claim 1, which is for executing a function of specifying a page number of a page of the paper book in which display information designated by the user through the operating portion is written in display information of the electronic book displayed on the display portion in the page-number specifying function.

3. The electronic-book display processing program according to claim 2, in which the storage unit stores the electronic book data including illustration data and illustration position information including page numbers of pages of the paper book in which an illustration corresponding to the illustration data is written, which is for executing a function of specifying a page number of a page of the paper book in which the illustration designated by the user through the operating portion is written in display information of the electronic book displayed on the display portion in the page-number specifying function.

4. The electronic-book display processing program according to claim 1, which further allows the computer to execute:
a layout setting function which stores layout information having been inputted by the user through the operating portion concerning a display state of the electronic book on the display portion in the storage unit, which is for executing a function of displaying a passage corresponding to part of the extracted electronic book data on the display portion in accordance with the layout information in the display control function.

5. The electronic-book display processing program according to claim 1, which further allows the computer to execute:
a layout setting function which stores layout information having been inputted by the user through the operating portion concerning a display state of the electronic book on the display portion in the storage unit, which is for executing a function of displaying a passage designated by the user through the operating portion in passages displayed on the display portion in accordance with the layout information after the passages corresponding to part of the extracted electronic book data are displayed on the display portion in the display control function.

6. The electronic-book display processing program according to claim 4, in which the storage unit stores the electronic book data including illustration data and illustration position information including a page number of a page of the paper book in which an illustration corresponding to the illustration data is written, which is for executing, in the display control function,
a function of displaying an illustration on the display portion with a passage based on the illustration data and illustration position information,
a function of determining whether the illustration can be displayed with a passage written in a page of the paper book including the illustration or not based on the illustration position information at the time of displaying the passage on the display portion based on the layout information, and
a function of adjusting a space between lines included in the layout information and displaying the illustration with part of the passage written in the page of the paper book including the illustration when the illustration is not able to be displayed with the passage.

7. The electronic-book display processing program according to claim 1, in which the storage unit stores the electronic book data including the document data of the electronic book associated with page numbers of plural types of the paper book, which is for executing
a function of extracting part of the electronic book data including data corresponding to a passage written in a page of the paper book corresponding to a page number based on the type and the page number of the paper book designated by the user through the operating portion of the terminal device in the passage specifying function, and
a function of specifying a page number of a page of the paper book in which part of display information is written from the electronic book data based on the type of the paper book designated by the user through the operating portion of the terminal device and the display information of the electronic book displayed on the display portion in the page-number specifying function.

8. An electronic-book display processing program for allowing a server device connected to a terminal device through a communication network, which has a display portion displaying a document of an electronic book which has the same content as a paper book based on electronic book data including document data of a reflowable format, to control the content of the electronic book to be displayed on the display portion, which allows the server device to execute:
a passage specifying function which extracts part of the electronic book data including data corresponding to a passage written in a page of the paper book corresponding to a page number based on the page number of the paper book designated by the user through an operating portion of the terminal device from a storage unit storing the electronic book data so as to be associated with page numbers of the paper book,
a page-number specifying function which specifies a page number of a page of the paper book in which at least part of display information is written from the electronic book data based on the display information of the electronic book displayed on the display portion, and
a display control function which displays the passage on the display portion based on the electronic book data,
wherein a passage corresponding to part of the extracted electronic book data is displayed on the display portion and the specified page number is displayed on the display portion in the display control function.

9. An electronic-book system including a terminal device having a display means for displaying a document of an electronic book which has the same content as a paper book based on electronic book data including document data of a reflowable format and a server device connected to the terminal device through a communication network, comprising:
a storage means for storing the electronic book data so as to be associated with page numbers of the paper book,
a passage specifying means for extracting part of the electronic book data including data corresponding to a passage written in a page of the paper book corresponding to a page number based on the page number of the paper book designated by the user from the storage means through an operating means of the terminal device,
a page-number specifying means for specifying a page number of a page of the paper book in which at least part of display information is written from the electronic book data based on the display information of the electronic book displayed on the display means, and
a display control means for displaying the document on the display means based on the electronic book data,
wherein the display control means displays the passage corresponding to part of the extracted electronic book data on the display means and displays the specified page number on the display means.
